(19) United States
(12) Patent Application Publication
(10) Pub. No.: US 2023/0196080 A1
(43) Pub. Date: Jun. 22, 2023

(54) METHOD AND SYSTEM FOR LOCAL EXPLAINABILITY OF NEURAL NETWORK PREDICTION FIELD

(71) Applicant: SAP SE, Walldorf (DE)

(72) Inventors: Waqas Ahmad Farooqi, Walldorf (DE); Eckehard Schmidt, Walldorf (DE); Jonas Benedict Grill, Mannheim (DE)

(73) Assignee: SAP SE, Walldorf (DE)

(21) Appl. No.: 17/555,245

(22) Filed: Dec. 17, 2021

(51) Int. Cl. G06N 3/04; G06N 3/08

(52) U.S. Cl. CPC G06N 3/0472; G06N 3/08

(57) ABSTRACT

A network output is generated by feeding an input vector to an input layer of a neural network model having a plurality of neurons arranged in a sequence of layers, a plurality of neuron weights, and a plurality of neuron biases. The network output is used to determine an output relevance score. Relevance scores at a last layer of the sequence of layers are generated. Relevance scores are obtained at a first layer of the sequence of layers by reverse propagating the relevance scores generated at the last layer through the sequence of layers other than the last layer using the neuron weights and neuron biases. A feature relevance vector is formed based on the input vector and the relevance scores obtained at the first layer and included in a local explainability dataset, which is then used to generate a local explanation of a prediction of the neural network model.

### FIELD

The field relates generally to artificial neural networks and explainable artificial intelligence.

### BACKGROUND

Deep learning allows for the development of more accurate artificial intelligence (AI) than other machine learning methods, even for complex data structures. Unlike conventional machine learning methods, a deep learning model can improve its predictions over time by continuously learning from new transactions. This process of continuous training can be automated, which can allow the deep learning model to remain current at all times.

However, it is challenging to use deep learning in applications where accountability and transparency are essential. This is because the learned patterns and embeddings in deep learning are hidden in a deep neural network (also called deep net) in the form of neuron weights and biases such that the factors that led to the predictions by the deep learning cannot be retrieved without complex and expensive analyses. This black box behavior of deep nets currently limits the usability of deep learning in practical domains where the users demand predictions along with the factors that led to the predictions.

### BRIEF DESCRIPTION OF THE DRAWINGS

FIG. 1 is a block diagram of an example system implementing explainable AI (XAI) generation.

FIG. 2 is a block diagram of an example method implementing XAI generation.

FIGS. 3A-3G are block diagrams illustrating working of an XAI model with a single-output neural network model, according to one example.

FIGS. 4A-4B are block diagrams illustrating working of an XAI model with a multi-output neuron network model, according to another example.

FIG. 5 is a block diagram illustrating an example system implementing XAI generation, according to another example.

FIG. 6 is a flowchart illustrating a method of implementing a generalized use case of XAI generation based on the system illustrated in FIG. 5, according to one example.

FIG. 7 is a block diagram of an example computing system in which described technologies can be implemented.

FIG. 8 is a block diagram of an example cloud computing environment that can be used in conjunction with the technologies described herein.

FIG. 9A is a test image showing an example purchase order document.

FIG. 9B is an example prediction of a trained neural network model for the test image shown in FIG. 9A.

FIG. 9C is a diagram illustrating a test image having n channels and a neural network model that receives an input vector representing the test image and makes a prediction.

FIG. 9D is a diagram illustrating an example local explanation generation where a relevance map for a prediction of a neural network model has the same dimensions as an input vector.

FIG. 9E is a diagram illustrating an example local explanation generation where a relevance map for a prediction of a neural network model has different dimensions compared to an input vector.

FIGS. 10A-10D show example user interfaces presenting an explanation of a prediction of a neural network model in a document image context.

### DETAILED DESCRIPTION

### Example A—Overview

Training of a deep neural network (DNN) model involves minimizing a loss function that compares a value predicted by the DNN model to an actual value. During the training, the DNN model learns to recognize and use the patterns in the data. In particular, the DNN model learns how to weight the individual features of the data and draw inferences from the data.

Technologies disclosed herein are based on the knowledge that the information about how the neural network model processes data is stored in the neuron weights and biases. Technologies disclosed herein can extract the feature relevance information stored in the neuron weights and biases and use the extracted information to explain the reasons behind predictions made by the neural network model. The described technologies can greatly enhance the usability of DNN models for applications sensitive to accountability and transparency and facilitate optimization of the DNN models.

### Example B—Example System Implementing XAI Generation

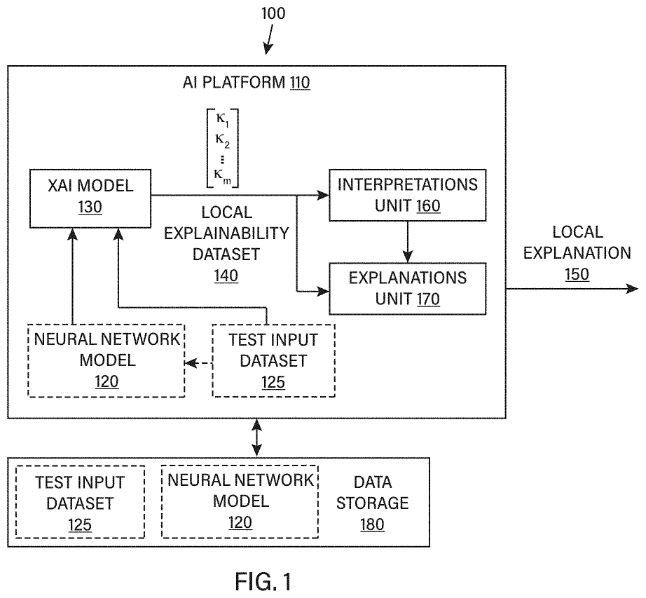

FIG. 1 is a block diagram of an example system 100 implementing explainable AI (XAI) generation. The example system 100 includes an AI platform 110 that can generate a local explanation 150 of a prediction made by a neural network model 120. The AI platform 110 can include one or more explanation and interpretation models. For illustrative purposes, the AI platform 110 is shown as including an XAI model 130 that is configured to generate a local explainability dataset 140, which can be outputted as the local explanation 150 or further processed to generate the local explanation 150. The XAI model 130 can receive the neural network model 120 and a test input dataset 125 as inputs.

The term “model” generally means a function encoded as a computer program. The neural network model 120 is configured to receive an input vector with one or more input features and generate one or more network outputs. In one implementation, the neural network model 120 can be a DNN model, which is a neural network model with at least two hidden layers. In one example, the DNN model can be a trained neural network model (hereafter, trained NN model). In machine learning, a model is trained to perform a task by running a machine learning algorithm on a dataset. Once the model has been trained for the task (i.e., the machine learning algorithm has found a function that is sufficiently accurate for performing the given task in terms of matching inputs to outputs in the dataset), the trained model can be used for making predictions on new examples or for making inferences. In general, the term “trained NN model” means that the weights and biases of the neural network model have been adjusted through training of the neural network model with dataset(s) for a particular task.

The test input dataset 125 can include one or more test input vectors to be fed into the input layer of the neural network model 120 to generate one or more predictions. Each unique test input vector can yield one or more unique predictions from the neural network model 120.

The local explainability dataset 140 generated by the XAI model 130 comprises one or more feature relevance vectors κ. Each feature relevance vector κ can have m relevance values, where m is the number of input features that the neural network model 120 is configured to receive (m is given by the number of input neurons in the neural network model) to perform a particular task. Each relevance value in the feature relevance vector κ corresponds to one of the input features for a given test input vector and quantifies the importance or relevance of the input feature to a prediction of the neural network model 120 for the given test input vector.

The AI platform 110 can include an interpretations unit 160, which can transform the feature relevance vectors in the local explainability dataset 140 into a form that can be visualized and/or interpreted by an end user. The transformations that can be carried out by the interpretations unit 160 include, but are not limited to, normalization, regularization, scaling, mapping to a higher or lower dimension space, transforming into a different numeric base system, transformation in frequency or time domain, and the like. The AI platform 110 can include an explanations unit 170, which can take the local explainability dataset 140 or the output of the interpretations unit 160 and map the data into a context that will be easily understood by the end user.

In a particular example, the XAI model 130 can generate the local explainability dataset 140. The interpretations unit 160 and/or explanations unit 170 can receive the local explainability dataset 140 from the XAI model 130 and transform the dataset into percentages and/or ratios. These percentages and/or ratios can be converted into histograms, pie and/or line graphs, heatmaps, and the like to give further insights. In some cases, the dataset could also be scaled or normalized. In some cases, word clouds or images can be generated. The results can be mapped into a context so that the relevance values in the local explainability dataset 140 are expressed in terms that the end user would easily understand and be able to act on.

The XAI model 130 can be a function (or functions) encoded as a computer program. Similarly, the interpretations unit 160 and explanations unit 170 can be computer programs. The system 100 can include a data storage 180 from which the AI platform 110 can fetch the neural network model 120 and the test input dataset 125. The AI platform 110 can additionally store the local explainability dataset 140 in the data storage 180. The AI platform 110 can also retrieve other data for use in the interpretations unit 160 and/or explanations unit 170.

The AI platform 110 can be implemented in a computer system. The AI platform 110 can be stored in one or more computer-readable storage media or computer-readable storage devices. The technologies described herein can be generic to the specifics of operating systems or hardware and can be applied in any variety of environments to take advantage of the described features.

### Example C—Example Method Implementing XAI Generation

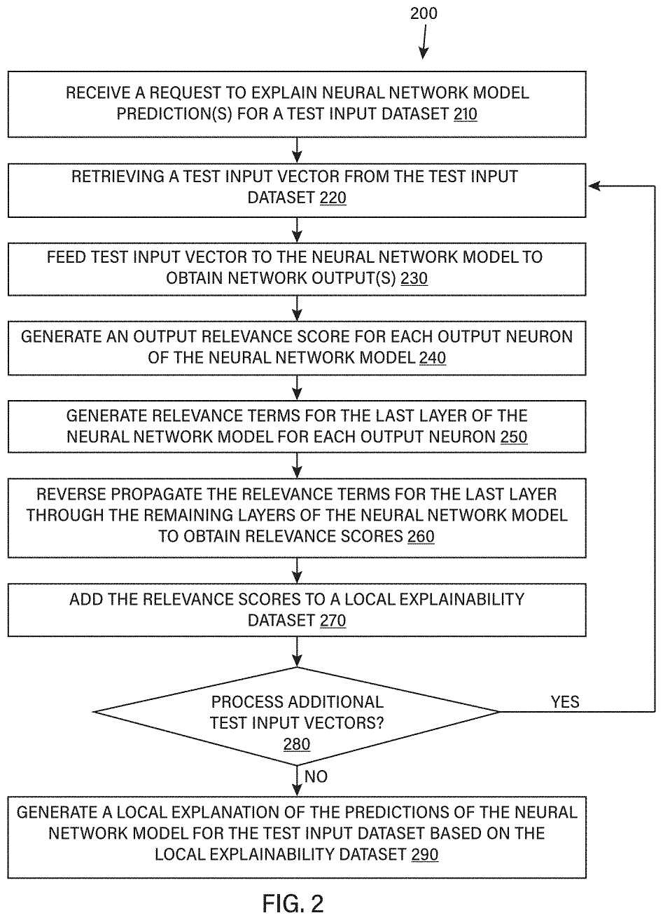

FIG. 2 is a flowchart of an example method 200 of generating a local explanation for a prediction made by a neural network model and can be performed, for example, by the system 100 (see Example B). The local explanation generated by the method 200 can be used to understand the prediction made by the neural network model for a given input vector.

In the example, at 210, the method receives a request to explain prediction(s) of a neural network model for a test input dataset, i.e., a request for a local explanation of the neural network model. The request can include sufficient information to retrieve the neural network model and the test input dataset from memory or storage device(s) or can include the neural network model and the test input dataset.

The neural network model has m input neurons in the input layer to receive an input vector with m input features. The neural network model has a plurality of neurons (i.e., other than the input neurons) arranged in a sequence of layers. The neural network model has neuron weights and biases distributed across the sequence of layers. In one example, the neural network model can be a trained NN model, which means that the neuron weights and biases have been set by training the neural network model for a particular task with dataset(s). In one example, the neural network model can be a trained DNN model.

In one example, the test input dataset includes one or more test input vectors. Each test input vector can have the number of input features the neural network model is configured to receive.

At 220, the method retrieves a test input vector from the test input dataset.

At 230, the method feeds the test input vector to the neural network model to obtain network output(s). The number of network outputs obtained will depend on the number of output neurons of the neural network model, with each output neuron being capable of producing a network output. In some cases, each output neuron of the neural network model includes an activation function to output a probability of prediction.

At 240, the method generates an output relevance score for each network output (or each output neuron) of the neural network model. In some cases, each output neuron outputs a probability of prediction, and the corresponding output relevance score is based on the probability of prediction. In other cases, the output neuron does not output a prediction probability, and a probability function is applied to the output of the output neuron to obtain a prediction probability and the output relevance score.

At 250, the method generates a plurality of relevance scores for the last layer of the neural network model (or for the last layer of the sequence of layers) for each output neuron. In one example, for each output neuron, the plurality of relevance scores are generated for the last layer based on the output relevance score determined for the output neuron, the neuron weights in the last layer of the sequence of layers, and the neuron biases in a lower layer preceding the last layer.

At 260, the method traverses the hidden layers of the sequence of layers in a reverse direction (i.e., from the last hidden layer preceding the last layer to the first hidden layer succeeding the input layer) for each output neuron. During this reverse traversal, the method propagates the relevance scores generated at the last layer at 250 through the sequence of layers, arriving at the first layer with a plurality of relevance scores. At each given hidden layer, the method computes a plurality of relevance scores at the given hidden layer based on neuron weights in the given hidden layer, neuron biases in a lower layer preceding the given hidden layer, and relevance scores in a higher layer succeeding the given hidden layer. In one example, neuron activations are not used in computing relevance scores at the hidden layers.

At 270, the method adds the relevance scores obtained at the first layer to a local explainability dataset. In one example, for each output neuron, a relevance vector κ^{L=1} can be populated with the relevance scores obtained at the first layer of the sequence of layers. The relevance vector will have a size m that is the same as the size of the test input vector such that each relevance score in the relevance vector has a corresponding input feature in the test input vector. The relevance vector and test input vector can be single dimensional vectors or high dimensional vectors. The dimension of the relevance vector and the test input vector can be the same or can be different. In cases where the dimensions of the relevance vector are not the same as the dimensions of the test input vector, a mapping technique can be used to map the relevance scores in the relevance vector to the input features in the test input vector. A feature relevance vector κ can be computed based on the relevance vector κ^{L=1} and the test input vector (e.g., by taking a dot product of the relevance vector and the test input vector). The feature relevance vector κ can be added to the local explainability dataset along with the corresponding test input vector and the corresponding network output.

At 280, the method determines if there are additional test input vectors in the test input dataset to process. If there are additional test input vectors to process, the method can return to operation 220 to retrieve another test input vector from the test input dataset. After retrieving another test input vector, the method can repeat operations 230-280.

At 290, the method uses the local explainability dataset to generate a local explanation of the prediction(s) made by the neural network model for the test input dataset. The local explanation can include various transformations of the local explainability dataset and metadata to facilitate understanding of the relevance scores in the dataset by an end user. For example, the explanation can include any of text, images, scores, percentages, graphs, histograms, and visual indicators configured to explain the local explainability dataset within a context of the end user.

The method 200 can be illustrated from alternative perspectives, e.g., from a perspective of an end user, which can be a human or a computer system or process. The method 200 and any of the other methods described herein can be performed by computer-executable instructions (e.g., causing a computing system to perform the method) stored in one or more computer-readable media (e.g., storage or other tangible media) or stored in one of more computer-readable storage devices. Such methods can be performed in software, firmware, hardware, or combinations thereof. Such methods can be performed at least in part by a computing system (e.g., one or more computing devices).

### Example D—Example XAI Model for Local Explainability

Local explainability can show the relevance or importance of the input features received at the input layer of the neural network model to the prediction made by the neural network model. In one example, an XAI model configured to generate local explainability dataset can be built with the following considerations:

The XAI model receives a neural network model and test input vector(s) as inputs. The neural network model can be any type of neural network that does not have loops. The neural network model is trained.

The XAI model calculates relevance scores of neurons in the neural network model using weights and biases of the neural network model.

The XAI model determines the relevance scores at the last layer based on the prediction probability of the neural network model for a given test input vector.

The XAI model reverse propagates relevance scores determined at the last layer through hidden layers of the neural network without using neuron activations in the hidden layers.

The XAI model is memory efficient. For example, once the relevance scores of a given layer L have been calculated using the relevance scores of a higher layer L+1, the relevance scores of the higher layer L+1 can be discarded since they will not be needed to generate the relevance scores of the lower layer L−1.

The XAI model corrects for extreme polarities in neuron weights. For example, in a given layer of the neuron network model, the neuron weights can be positive or negative. If one neuron with a particularly negative value and another neuron with a particularly positive value enter one layer of the network, these two neurons might influence the results strongly in that layer, but in the next layer, the effect can be balanced out. To overcome this, absolute values of neuron weights can be considered in calculations of the relevance scores. Other approaches can include using non-linear operations, e.g., root mean square.

In the example, the XAI model can output local explainability dataset comprising one or more feature relevance vectors, one or more test input vectors, and one or more predictions corresponding to the one or more test input vectors. Each feature relevance vector can have the same size (i.e., number of relevance scores) as the number of input features of the neural network model (as determined by the number of input neurons of the neural network model). Each relevance score represented in the feature relevance vector corresponds to one of the input features of a test input vector and quantifies the relevance of the input feature to the prediction made by the neural network model for the test input vector.

In one implementation, computation of a feature relevance vector can start with computing an output relevance of each output neuron of the neural network model for a given input vector.

In one example, the output relevance of a single output neuron of the neural network model can be expressed as:

yₒ=|ŷ−t|+ε (1a)

In Equation (1a), ŷ is probability of predicted output, t is threshold parameter, and ε is a parameter to avoid yₒ with a zero value. The value of c is usually very small, e.g., 10⁻⁶.

Equation (1a) assumes that the output neuron outputs prediction probability. If the output neuron does not output prediction probability, the output relevance can be expressed as follows:

yₒ=|P(ŷ)−t|+ε (1b)

In Equation (1b), is predicted output, P(ŷ) is probability of predicted output, and ε is a parameter to avoid yₒ with a zero value. The value of ε is usually very small, e.g., 10⁻⁶.

If the neural network model has multiple output neurons, the output relevance of each of the output neurons of the neural network model can be expressed as:

yₒ=ŷ+ε (2a)

In Equation (2a), ŷ is probability of predicted output, and ε is a parameter to avoid yₒ with a zero value. The value of ε is usually very small, e.g., 10⁻⁶.

Equation (2a) assumes that the output neurons output prediction probabilities. If the output neurons do not output prediction probabilities, the output relevance of each of the output neurons can be expressed as:

yₒ=P(ŷ)+ε (2b)

In Equation (2b), ŷ is predicted output, P(ŷ) is probability of predicted output, and ε is a parameter to avoid yₒ with a zero value. The value of ε is usually very small, e.g., 10⁻⁶.

The predicted output or probability of predicted output in Equations (1a) to (2b) can be obtained by feeding a test input vector to the neural network model.

Computation of the feature relevance vector can further include computing relevance at the last layer (or output layer) of the neural network model. The relevance at the last layer of the neural network model can be expressed as follows:

$${\underline{κ}}^{L} = ( α {\underline{w}}^{L} {y}_{0} + β {\underline{b}}^{L - 1} ) \frac{1}{{λ}^{L}} \qquad ( 3 )$$

$$[ \begin{matrix}\begin{matrix}\begin{matrix}\begin{matrix}{κ}_{1}^{L} \\ {κ}_{2}^{L}\end{matrix} \\ {κ}_{3}^{L}\end{matrix} \\ ⋮\end{matrix} \\ {κ}_{θ}^{L}\end{matrix} ] = ( α [ \begin{matrix}\begin{matrix}\begin{matrix}\begin{matrix}{w}_{11}^{L} \\ {w}_{21}^{L}\end{matrix} \\ {w}_{31}^{L}\end{matrix} \\ ⋮\end{matrix} \\ {w}_{θ1}^{L}\end{matrix} ] {y}_{o} + [ \begin{matrix}\begin{matrix}\begin{matrix}\begin{matrix}{b}_{1}^{L - 1} \\ {b}_{2}^{L - 1}\end{matrix} \\ {b}_{3}^{L - 1}\end{matrix} \\ ⋮\end{matrix} \\ {b}_{θ}^{L - 1}\end{matrix} ] ) \frac{1}{{λ}^{L}} \qquad ( 4 )$$

$${κ}_{i}^{L} = ( α {w}_{i j}^{L} {y}_{o} + β {b}_{i}^{L - 1} ) \frac{1}{{λ}^{L}} = ( {\sum }_{i} ( α {w}_{i j}^{L} {y}_{o} , β {b}_{i}^{L - 1} ) ) \frac{1}{{λ}^{L}} \qquad ( 5 )$$

Equations (3) to (5) are equivalent but use different notations or mathematical structures. Equation (3) is a generic form of the expression, Equation (4) is a vector representation of the expression, and Equation (5) is a scalar representation of the expression. In Equations (3) to (5), κᵢ^{L} is a relevance value of an i^{th} neuron in a layer L−1 to the layer L; i is the i^{th} neuron in the layer L−1 (i.e., i=1, 2, 3, . . . , θ, where θ is the total number of neurons in the layer L−1); wᵢⱼ^{L} is a weight in the layer L (or a weight connecting an i^{th} neuron in the layer L−1 to j^{th} neurons in the layer L (j=1, 2, 3, . . . c, where c is the number of neurons in the last layer)); bᵢ^{L-1} is a bias term for an i^{th} neuron in the layer L−1; λ^{L} is the total number of neurons in the layer L; α is a scalar scaling factor; and β is a scalar scaling factor, and y₀ is output relevance, which can be determined using one of Equations (1a) to (2b).

Computation of the feature relevance vector can further include computing the relevance at each hidden layer of the neural network model in a reverse direction (i.e., from the last hidden layer to the first hidden layer). In one example, the relevance at each hidden layer can be expressed as follows:

$${\underline{κ}}^{L} = ( α {W}^{L} {\underline{κ}}^{L + 1} + β {b}^{L - 1} ) \frac{1}{{λ}_{L}} ◻ \qquad ( 6 )$$

$$▯ [ \begin{matrix}\begin{matrix}\begin{matrix}\begin{matrix}{κ}_{1}^{L} \\ {κ}_{2}^{L}\end{matrix} \\ {κ}_{3}^{L}\end{matrix} \\ ⋮\end{matrix} \\ {κ}_{θ}^{L}\end{matrix} ] = ( α [ \begin{matrix}{w}_{11}^{L} & {w}_{12}^{L} & {w}_{13}^{L} & … & {w}_{1 λ}^{L} \\ {w}_{21}^{L} & {w}_{22}^{L} & {w}_{23}^{L} & … & {w}_{2 λ}^{L} \\ {w}_{31}^{L} & {w}_{32}^{L} & {w}_{33}^{L} & … & {w}_{3 λ}^{L} \\ ⋮ & ⋮ & ⋮ & … & ⋮ \\ {w}_{θ1}^{L} & {w}_{θ2}^{L} & {w}_{θ3}^{L} & … & {w}_{θλ}^{L}\end{matrix} ] [ \begin{matrix}\begin{matrix}\begin{matrix}\begin{matrix}{κ}_{1}^{L + 1} \\ {κ}_{2}^{L + 1}\end{matrix} \\ {κ}_{3}^{L + 1}\end{matrix} \\ ⋮\end{matrix} \\ {κ}_{λ}^{L + 1}\end{matrix} ] + β [ \begin{matrix}\begin{matrix}\begin{matrix}\begin{matrix}{b}_{1}^{L - 1} \\ {b}_{2}^{L - 1}\end{matrix} \\ {b}_{3}^{L - 1}\end{matrix} \\ ⋮\end{matrix} \\ {b}_{θ}^{L - 1}\end{matrix} ] ) \frac{1}{{λ}^{L}} \qquad ( 7 )$$

$${κ}_{i}^{L} = ( {\sum }_{j} ( α {w}_{ij}^{L} {κ}_{j}^{L + 1} ) + β {b}_{i}^{L - 1} ) \frac{1}{{λ}^{L}} \qquad ( 8 )$$

Equations (6) to (8) are equivalent but use different notations or mathematical structures. In Equations (6) to (8), κᵢ^{L} is a relevance value of an i^{th} neuron in a lower layer L−1 to a given layer L; i is the i^{th} neuron in the lower layer L−1 (i.e., i=1, 2, 3, . . . , θ, where θ is the total number of neurons in the layer L−1); wᵢⱼ^{L} is a weight in the given layer L connecting an i^{th} neuron in the lower layer L−1 to j^{th} neurons in the given layer L; bᵢ^{L-1} is a bias term for an i^{th} neuron in the lower layer L−1, λ^{L} is the total number of neurons in the given layer L, α is a scalar scaling factor, and β is a scalar scaling factor. L is in a range from 1 to N, where N is the total number of hidden layers in the neural network.

The final result of applying Equations (6) to (8) sequentially to the hidden layers is a relevance vector κ^{L=1} at the first hidden layer. The feature relevance vector κ^{F} for a given test input vector can be obtained as follows:

$${\underline{κ}}^{F} = α ( \underline{x} ⊙ {\underline{κ}}^{L = 1} ) \qquad ( 9 )$$

$$[ \begin{matrix}\begin{matrix}\begin{matrix}\begin{matrix}{κ}_{1}^{F} \\ {κ}_{2}^{F}\end{matrix} \\ {κ}_{3}^{F}\end{matrix} \\ ⋮\end{matrix} \\ {κ}_{θ}^{F}\end{matrix} ] = α ( [ \begin{matrix}\begin{matrix}\begin{matrix}\begin{matrix}{x}_{1} \\ {x}_{2}\end{matrix} \\ {x}_{3}\end{matrix} \\ ⋮\end{matrix} \\ {x}_{θ}\end{matrix} ] ⊙ [ \begin{matrix}\begin{matrix}\begin{matrix}\begin{matrix}{κ}_{1}^{L = 1} \\ {κ}_{2}^{L = 1}\end{matrix} \\ {κ}_{3}^{L = 1}\end{matrix} \\ ⋮\end{matrix} \\ {κ}_{θ}^{L = 1}\end{matrix} ] \qquad ( 10 )$$

$${κ}_{i}^{F} = α ( {x}_{i} {κ}_{i}^{L = 1} ) \qquad ( 11 )$$

Equations (9) to (11) are equivalent expressions using different mathematical notations and structures. In Equations (9) to (11), i is the i^{th} input feature (i.e., i=1, 2, 3, . . . , θ, where θ is the total number of input features, which is the same as the total number of input neurons of the neural network model), xᵢ is the value of an i^{th} input feature, κᵢ^{F} is a feature relevance score of an i^{th} input feature, κᵢ^{L=1} is a relevance score at the first hidden layer (L=1) corresponding to an i^{th} input feature, α is a scalar scaling factor, and ⊙ is Hadamard product or Schur product.

### Example E—Example Working of the XAI Model

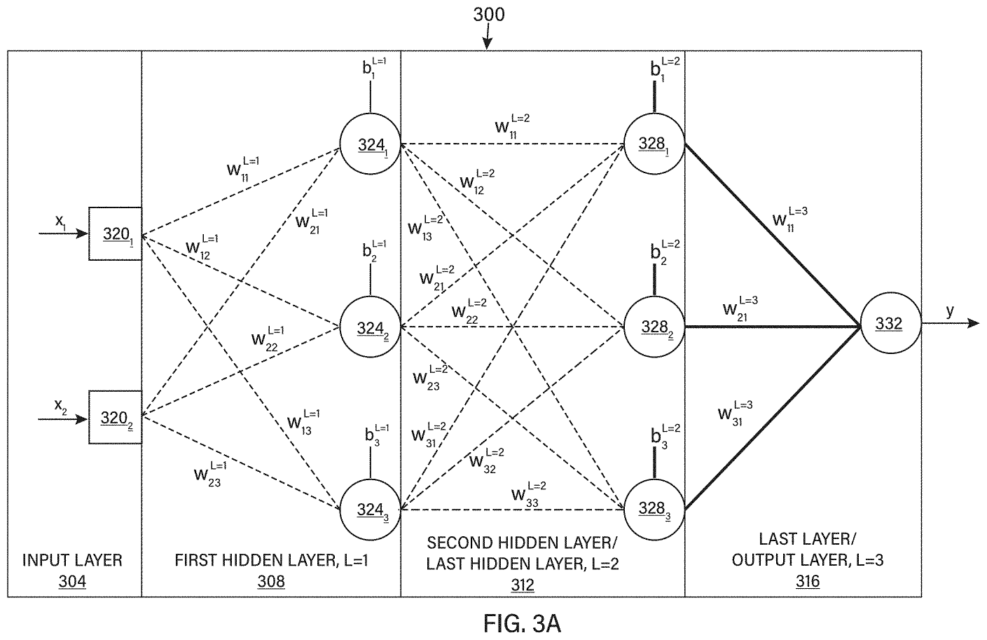

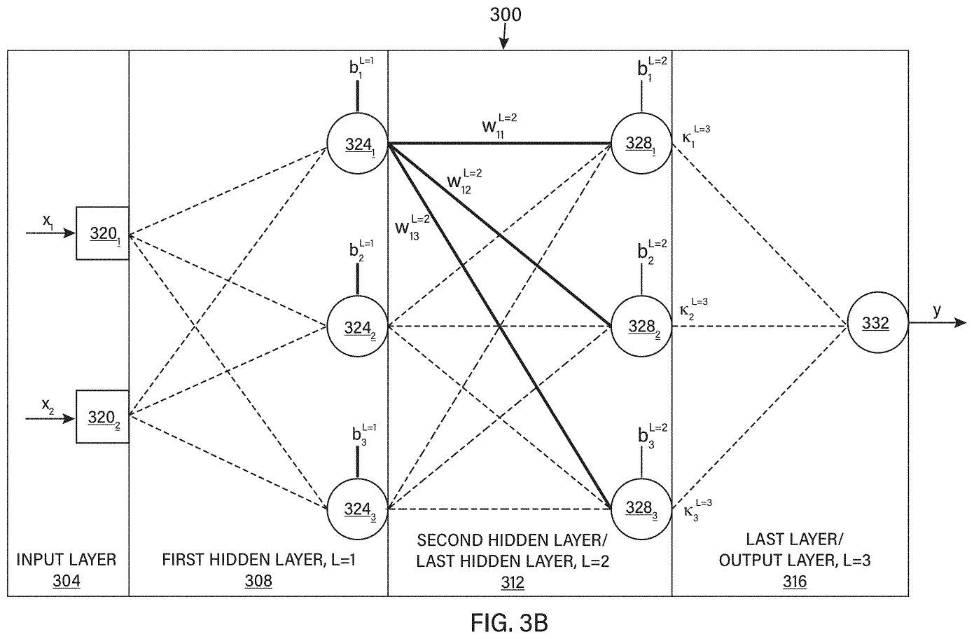

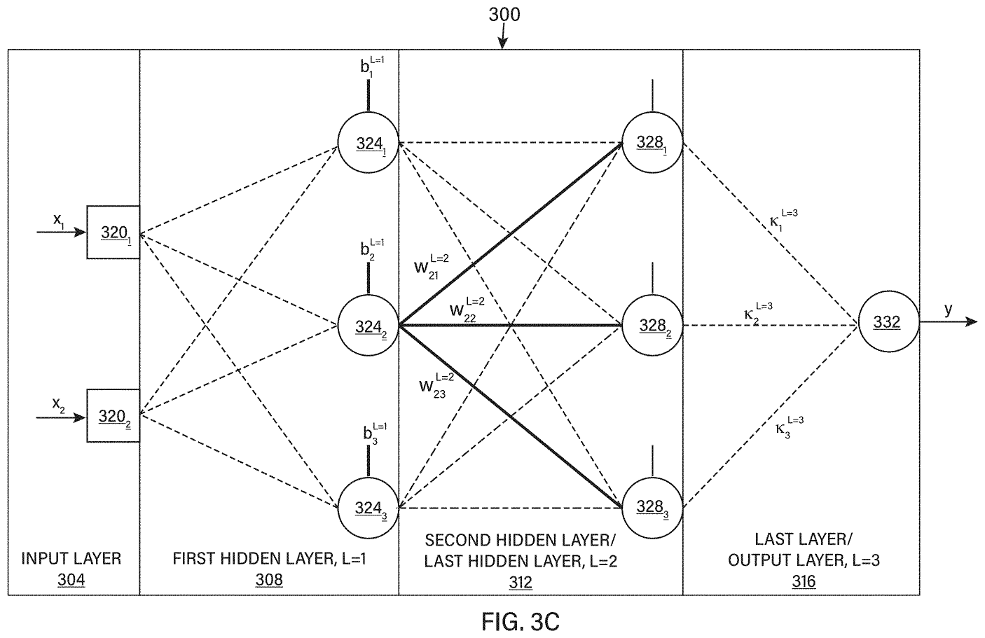

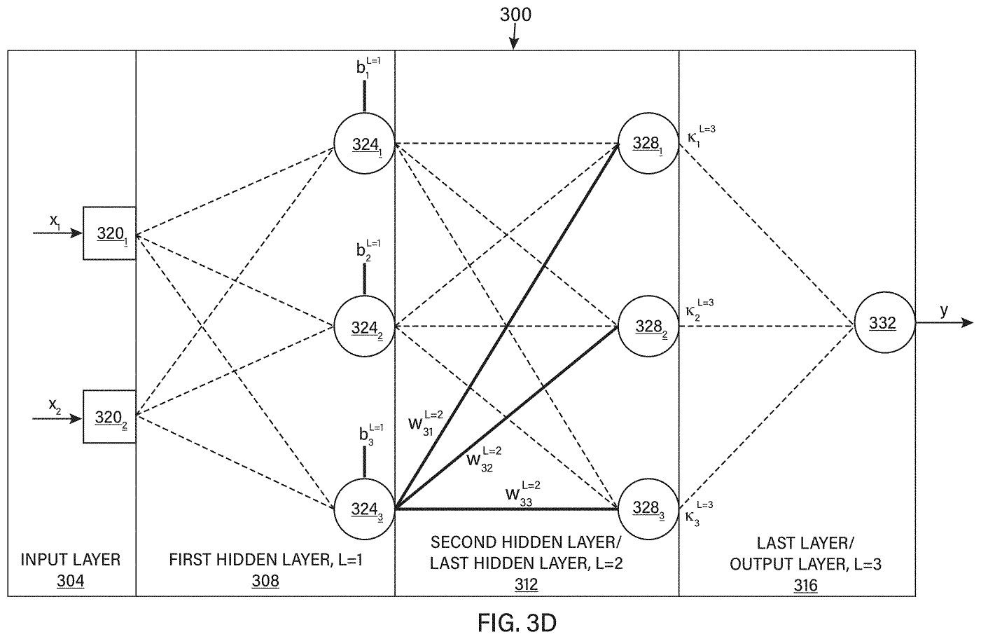

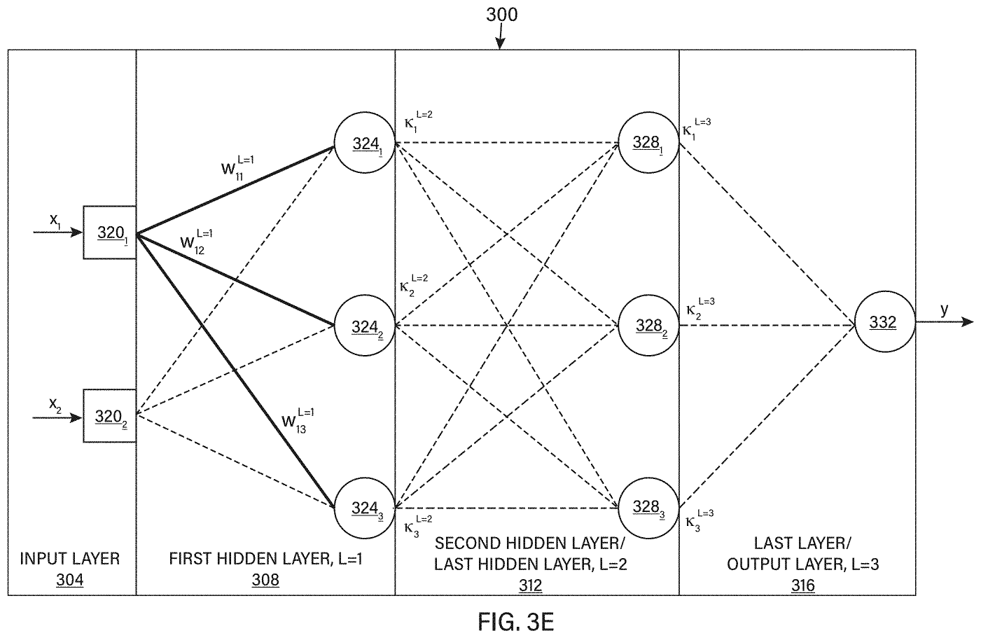

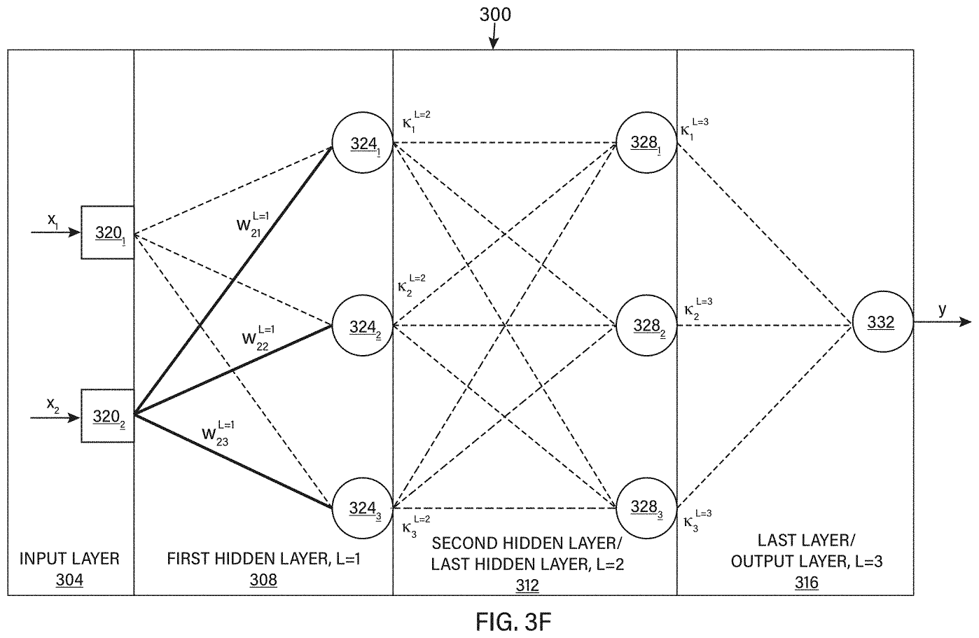

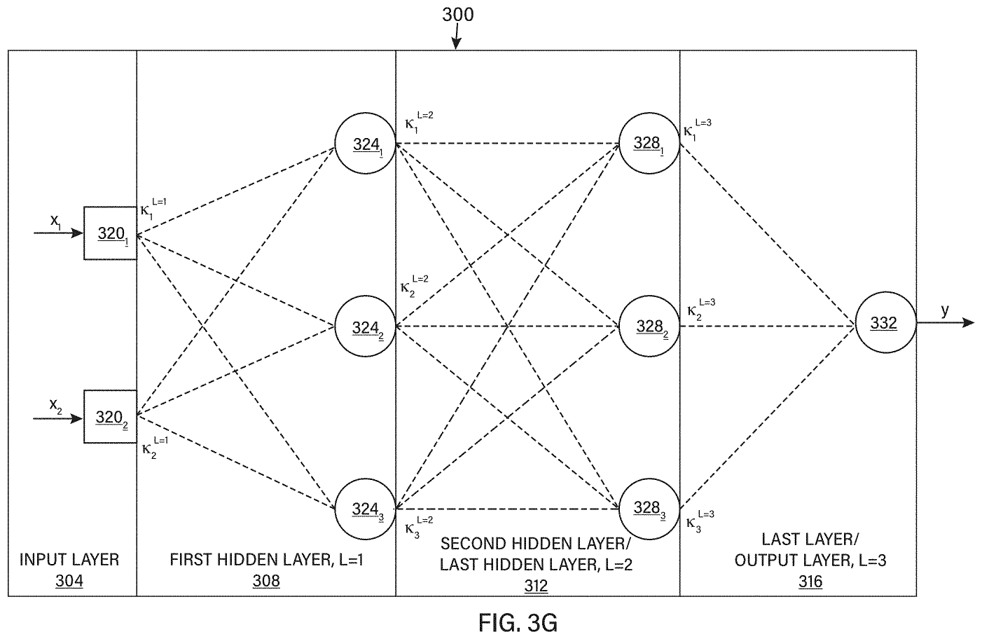

FIGS. 3A-3G illustrate an example of how the XAI model (see Example D) works.

The working of the XAI model is described relative to a neural network model 300 that is configured to generate an output y from an input vector x.

The neural network model 300 includes an input layer 304, a first hidden layer 308, a second hidden layer 312 (which is also the last hidden layer), and a last layer 316 (which is also the output layer). The neural network model 300 receives input data through the input layer 304. The hidden layers 308, 312 are where manipulation of the input data occurs. The layers 308, 312 are called hidden because their workings are not directly accessible from outside the neural network. Also, the hidden layers are intermediate layers between the input layer 304 and the last layer 316. The last layer 316 is the final product of manipulating the data in the network. Although the neural network model 300 is illustrated as a feed forward network, the XAI model is not restricted to feed forward networks and could be used with any neural network model that does not have loops.

In the illustrated example, the input layer 304 has a first neuron 320₁ that can sense an input feature x₁ and a second neuron 320₂ that can sense an input feature x₂. As an example, a neural network model configured to map an image to an object can sense input features related to the image, such as edges in the image, pixel intensity, and so on. The first hidden layer 308 includes a first neuron 324₁, a second neuron 324₂, and a third neuron 324₃ for manipulating data within the network. The second hidden layer 312 includes a first neuron 328₁, a second neuron 328₂, and a third neuron 328₃ for manipulating data within the network. The output layer 316 includes an output neuron 332 that produces an output y. As such, the neural network model 300 is configured to map inputs x₁, x₂ to output y.

The neural network model 300 is an example of a deep neural network (DNN) in that the network has more than one hidden layer. The neural network model 300 can have far more hidden layers than the two hidden layers illustrated in FIG. 3A. For simplicity, the neural network model 300 is shown in FIG. 3A as having only one output neuron 332 in the output layer 316. In other examples, the neural network model 300 can be configured to have multiple output neurons in the output layer. In general, the neural network model 300 can have far more numerous neurons and layers than illustrated in FIG. 3A.

The first neuron 324₁ in the first hidden layer 308₁ is connected to the first neuron 320₁ in the input layer 304 via a connection with weight w₁₁^{L=1} and to the second neuron 320₂ in the input layer 304 via a connection with weight w₂₁^{L=1}. The first neuron 324₁ also has a bias b₁^{L=1}. The second neuron 324₂ in the first hidden layer 308 is connected to the first neuron 320₁ in the input layer 304 via a connection with weight w₁₂^{L=1} and to the second neuron 320₂ in the input layer 304 via a connection with weight w₂₂^{L=1}. The second neuron 324₂ also has a bias b₂^{L=1}. The third neuron 324₃ in the first hidden layer 308 is connected to the first neuron 320₁ in the input layer 304 via a connection with weight w₁₃^{L=1} and to the second neuron 320₂ in the input layer 304 via a connection with weight w₂₃^{L=1}. The third neuron 324₃ also has a bias b₃^{L=1}.

The first neuron 328₁ in the second hidden layer 312 is connected to the first, second, and third neurons 324₁, 324₂, 324₃ of the first hidden layer 308 via connections with weights w_{11L}^{L=2}, w₂₁^{L=2}, and w₃₁^{L=2}, respectively. The first neuron 328₁ also has a bias b₁^{L=2}. The second neuron 328₂ in the second hidden layer 312 is connected to the first, second, and third neurons 324₁, 324₂, 324₃ of the first hidden layer 308 via connections with weights w₁₂^{L=2}, w₂₂^{L=2}, and w₃₂^{L=2}, respectively. The second neuron 328₂ is also connected to a bias b₂^{L=2}. The third neuron 328₃ in the second hidden layer 312 is connected to the first, second, and third neurons 324₁, 324₂, 324₃ of the first hidden layer 308 via connections with weights w₁₃^{L=2} w₂₃^{L=2}, and w₃₃^{L=2}, respectively. The third neuron 328₃ is also connected to a bias b₃^{L=2}. The output neuron 332 is connected to the first, second, and third neurons 328₁, 328₂, 328₃ via connections with weights w₁₁^{L=3}, w₂₁^{L=3}, and w₃₁^{L=3}, respectively.

Relevance calculation starts with feeding a test input vector to the neural network model to generate a predicted output or a probability of predicted output. Based on the predicted output or probability of predicted output, an output relevance is determined for the output neuron that generated the predicted output or probability of predicted output. This operation does not change the neuron weights and biases of the neural network model. After obtaining the output relevance of the output neuron, the relevance at the last layer of the neural network model is computed. The hidden layers of the neural network are then traversed sequentially from the last hidden layer to the first hidden layer while calculating relevance scores, ending at the first hidden layer with a set of relevance scores corresponding to the set of input features specified by the test input vector.

FIG. 3A illustrates calculation of the relevance at the last layer (or output layer) 316 (L=3). In FIG. 3A, the weight w₁₁^{L=3} connecting the output neuron 332 in the last layer 316 to the first neuron 328₁ in the last hidden layer (or second hidden layer) 312 (L=2), the bias b₁^{L=2} of the first neuron 328₁, and the prediction probability at the output neuron 332 for a particular test input vector fed to the neural network model are used to calculate a first relevance value κ₁^{L=3} (shown in FIG. 3B) at the last layer 316 according to Equations (3) to (5) in Example D.

The weight w₂₁^{L=3} connecting the output neuron 332 to the second neuron 328₂ in the last hidden layer 312 and the bias b₂₁^{L=2} of the second neuron 328₂ are used to calculate a second relevance value κ₂^{L=3} (shown in FIG. 3B) at the last layer 316 according to Equations (3) to (5) in Example D.

The weight w₃₁^{L=3} connecting the output neuron 332 to the third neuron 328₃ in the last hidden layer 312 and the bias b₃^{L=2} of the third neuron 328₃ are used to calculate a third relevance value κ₃^{L=3} (shown in FIG. 3B) at the last layer 316 according to Equations (3) to (5) in Example D.

The relevance scores at the last layer (L=3) can be expressed as follows:

$${κ}_{1}^{L = 3} = ( α {w}_{11}^{L = 3} {y}_{o} + β {b}_{1}^{L = 2} ) \frac{1}{{λ}^{L = 3}} \qquad ( 12 a )$$

$${κ}_{2}^{L = 3} = ( α {w}_{21}^{L = 3} {y}_{o} + β {b}_{2}^{L = 2} ) \frac{1}{{λ}^{L = 3}} \qquad ( 12 b )$$

$${κ}_{3}^{L = 3} = ( α {w}_{31}^{L = 3} {y}_{o} + β {b}_{3}^{L = 2} ) \frac{1}{{λ}^{L = 3}} \qquad ( 12 c )$$

FIGS. 3B-3D illustrate calculation of the relevance at the last hidden layer (or second hidden layer) 312 (L=2). In FIG. 3B, the weights w₁₁^{L=2}, w₁₂^{L=2}, and w₁₃^{L=2} connecting the first neuron 324₁ in the first hidden layer 308 (L=1) to the neurons 328₁, 328₂, 328₃ in the last hidden layer 312, the bias b₁^{L=1} of the first neuron 324₁, and the relevance values at the last layer (or output layer) 316 (L=3) are used to calculate a first relevance value κ₁^{L=2} (shown in FIG. 3E) at the last hidden layer 312 according to Equations (6) to (8) in Example D.

In FIG. 3C, the weights w₂₁^{L=2}, w₂₂^{L=2}, and w₂₃^{L=2} connecting the second neuron 324₂ in the first hidden layer 308 to the neurons 328₁, 328₂, 328₃ in the second hidden layer 312, the bias b₂^{L=1} of the second neuron 324₂, and the relevance values at the last layer 316 (L=3) are used to calculate a second relevance value κ₂^{L=2} (shown in FIG. 3E) at the last hidden layer 312 according to Equations (6) to (8) in Example D.

In FIG. 3D, the weights w₃₁^{L=2}, w₃₂^{L=2}, and w₃₃^{L=2} connecting the third neuron 324₃ in the first hidden layer 308 to the neurons 328₁, 328₂, 328₃ in the last hidden layer 312, the bias b₃^{L=1} of the third neuron 324₃, and the relevance values at the last layer 316 are used to calculate a third relevance value κ₃^{L=2} (shown in FIG. 3E) at the last hidden layer 312 according to Equations (6) to (8) in Example D.

The relevance scores at the last hidden layer 312 (L=2) can be expressed as follows:

$${κ}_{1}^{L = 2} = ( α ( {w}_{11}^{L = 2} {κ}_{1}^{L = 3} + {w}_{12}^{L = 2} {κ}_{2}^{L = 3} + {w}_{13}^{L = 2} {κ}_{3}^{L = 3} ) + β {b}_{1}^{L = 1} ) \frac{1}{{λ}^{L = 2}} \qquad ( 13 a )$$

$${κ}_{2}^{L = 2} = ( α ( {w}_{21}^{L = 2} {κ}_{1}^{L = 3} + {w}_{22}^{L = 2} {κ}_{2}^{L = 3} + {w}_{23}^{L = 2} {κ}_{3}^{L = 3} ) + β {b}_{2}^{L = 1} ) \frac{1}{{λ}^{L = 2}} \qquad ( 13 b )$$

$${κ}_{3}^{L = 2} = ( α ( {w}_{31}^{L = 2} {κ}_{1}^{L = 3} + {w}_{32}^{L = 2} {κ}_{2}^{L = 3} + {w}_{33}^{L = 2} {κ}_{3}^{L = 3} ) + β {b}_{3}^{L = 1} ) \frac{1}{{λ}^{L = 2}} \qquad ( 13 c )$$

After calculating the relevance scores at the last hidden layer 312 (L=2), the relevance scores calculated at the last layer 316 (L=3) can be discarded for memory efficiency.

FIGS. 3E-3F illustrate calculation of the relevance at the first hidden layer 308 (L=1). In FIG. 3E, the weights w₁₁^{L=1}, w₁₂^{L=1}, and w₁₃^{L=1} connecting the input neuron 320₁ to the neurons 324₁, 324₂, 324₃ of the first hidden layer 308 and the relevance scores associated with the last hidden layer 312 (L=2) are used to calculate a first relevance score κ₁^{L=1} (shown in FIG. 3G) at the first hidden layer 308.

In FIG. 3F, the weights w₂₁^{L=1}, w₂₂^{L=1}, and w₂₃^{L=1} connecting the input neuron 320₂ to the neurons 324₁, 324₂, 324₃ of the first hidden layer 308 and the relevance scores at the last hidden layer 312 are used to calculate a second relevance value κ₂^{L=1} (shown in FIG. 3G) at the first hidden layer 308.

The relevance scores at the first hidden layer 308 (L=1) can be expressed as follows:

$${κ}_{1}^{L = 1} = ( α ( {w}_{11}^{L = 1} {κ}_{1}^{L = 2} + {w}_{12}^{L = 1} {κ}_{2}^{L = 2} + {w}_{13}^{L = 1} {κ}_{3}^{L = 2} ) ) \frac{1}{{λ}^{L = 1}} \qquad ( 14 a )$$

$${κ}_{2}^{L = 1} = ( α ( {w}_{21}^{L = 1} {κ}_{1}^{L = 2} + {w}_{22}^{L = 1} {κ}_{2}^{L = 2} + {w}_{23}^{L = 1} {κ}_{3}^{L = 2} ) ) \frac{1}{{λ}^{L = 1}} \qquad ( 14 b )$$

After calculating the relevance scores at the first hidden layer 308, the relevance scores calculated at the last hidden layer 312 (L=2) can be discarded for memory efficiency.

The relevance scores κ₁^{L=1}, κ₂^{L=1} calculated at the first hidden layer 308 (L=1) are shown in FIG. 3G. A relevance vector can be populated with the relevance scores κ₁^{L=1}, κ₂^{L=1}.

A feature relevance vector based on the relevance vector and the input vector can be determined according to Equations (9) to (11). The feature relevance vector can be expressed as follows:

$$[ \begin{matrix}{κ}_{1}^{F} \\ {κ}_{2}^{F}\end{matrix} ] = [ \begin{matrix}α {x}_{1} {κ}_{1}^{L = 1} \\ α {x}_{2} {κ}_{2}^{L = 1}\end{matrix} ] \qquad ( 15 )$$

In Equation (15), α is a scalar scaling factor, x₁, x₂ are input features, and κ₁^{L=1}, κ₂^{L=1} are relevance scores at the first hidden layer (L=1). The final output of the XAI model can be the feature relevance vector. The local explainability dataset can include the feature relevance vector along with other data, e.g., the test input vector corresponding to the feature relevance vector and the predicted output or probability of predicted output used in computing the output relevance corresponding to the feature relevance vector. A local explanation of the neural network model 300 can be generated based on the local explainability dataset.

### Example F—Example Working of the XAI Model with Multi-Output Neural Network Model

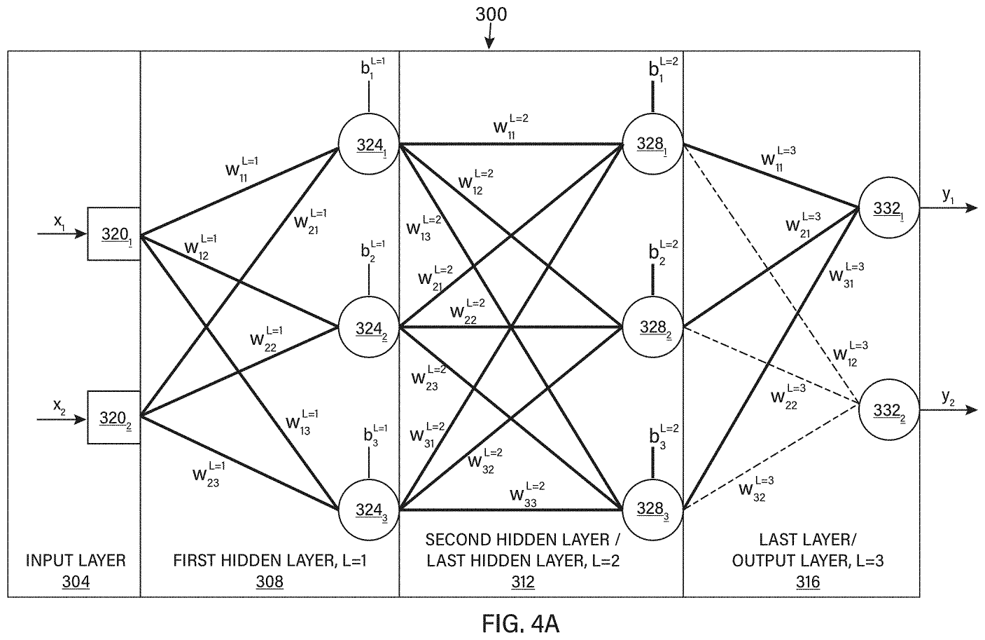

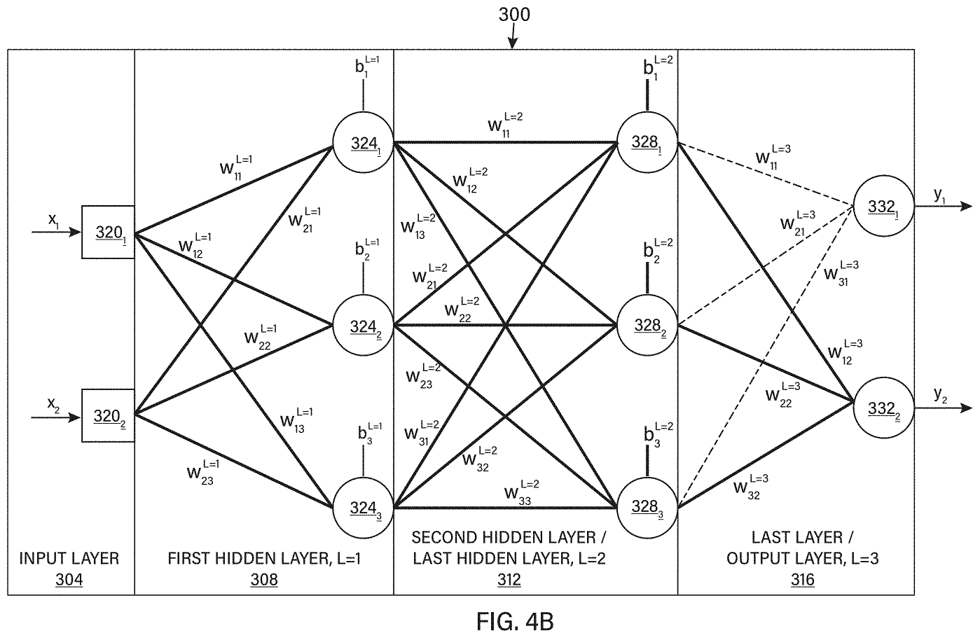

For a neural network model with multiple output neurons in the last layer, the calculations in Equations (1a) to (11) (see Example E) are performed for each of the output neurons. For example, FIGS. 4A and 4B show the neural network model 300 modified to include two output neurons 332₁, 332₂. FIG. 4A shows the path from the input neurons to the output neuron 332₁ across the sequence of layers with bold lines, and FIG. 4B shows the path from the input neurons to the output neuron 332₂ in bold lines. After computing the output relevance for the output neuron 332₁, relevance scores can be computed according to the path highlighted in FIG. 4A to obtain a feature relevance vector corresponding to the output neuron 332₁. Similarly, after computing the output relevance for the output neuron 332₂, relevance scores can be computed according to the path highlighted in FIG. 4B to obtain a feature relevance vector corresponding to the output neuron 332₂.

The process for computing the feature relevance vectors for the paths shown in FIGS. 4A and 4B is the same as described for computing the feature relevance vector in FIGS. 3A-3G, with the exception of the particular weights involved in the computations at the last layer. For the path shown in FIG. 4A, the relevant weights in the last layer are those that connect the neurons in the last hidden layer 312 (L=2) to the output neuron 332₁ in the last layer 316 (L=3). Where y₁ is the output relevance computed for the output neuron 332₁, the relevance scores at the last layer for the output neuron 332₁ can be expressed as:

$${κ}_{1}^{L = 3} = ( α {w}_{11}^{L = 3} {y}_{1} + β {b}_{1}^{L = 2} ) \frac{1}{{λ}^{L = 3}} \qquad ( 16 a )$$

$${κ}_{2}^{L = 3} = ( α {w}_{21}^{L = 3} {y}_{1} + β {b}_{2}^{L = 2} ) \frac{1}{{λ}^{L = 3}} \qquad ( 16 b )$$

$${κ}_{3}^{L = 3} = ( α {w}_{31}^{L = 3} {y}_{1} + β {b}_{3}^{L = 2} ) \frac{1}{{λ}^{L} = 3} \qquad ( 16 c )$$

For the path shown in FIG. 4B, the relevant weights in the last layer are those that connect the neurons in the last hidden layer 312 (L=2) to the output neuron 332₂ in the last layer 316 (L=3). Where y₂ is the output relevance computed for the output neuron 332₂, the relevance scores at the last layer for the output neuron 332₂ can be expressed as:

$${κ}_{1}^{L = 3} = ( α {w}_{12}^{L = 3} {y}_{2} + β {b}_{1}^{L = 2} ) \frac{1}{{λ}^{L = 3}} \qquad ( 17 a )$$

$${κ}_{2}^{L = 3} = ( α {w}_{22}^{L = 3} {y}_{2} + β {b}_{2}^{L = 2} ) \frac{1}{{λ}^{L = 3}} \qquad ( 17 b )$$

$${κ}_{3}^{L = 3} = ( α {w}_{32}^{L = 3} {y}_{2} + β {b}_{3}^{L = 2} ) \frac{1}{{λ}^{L = 3}} \qquad ( 17 c )$$

Thus, in the example in FIGS. 4A and 4B, there will be two feature relevance vectors—one feature relevance vector for the output neuron 332₁ and another feature relevance vector for the output neuron 332₂. In general, if there are n output neurons, there will be n feature relevance vectors. These feature relevance vectors can be added to the local explainability dataset for generation of local explanation.

### Example G—Example System Implementing Local Explanation Generation

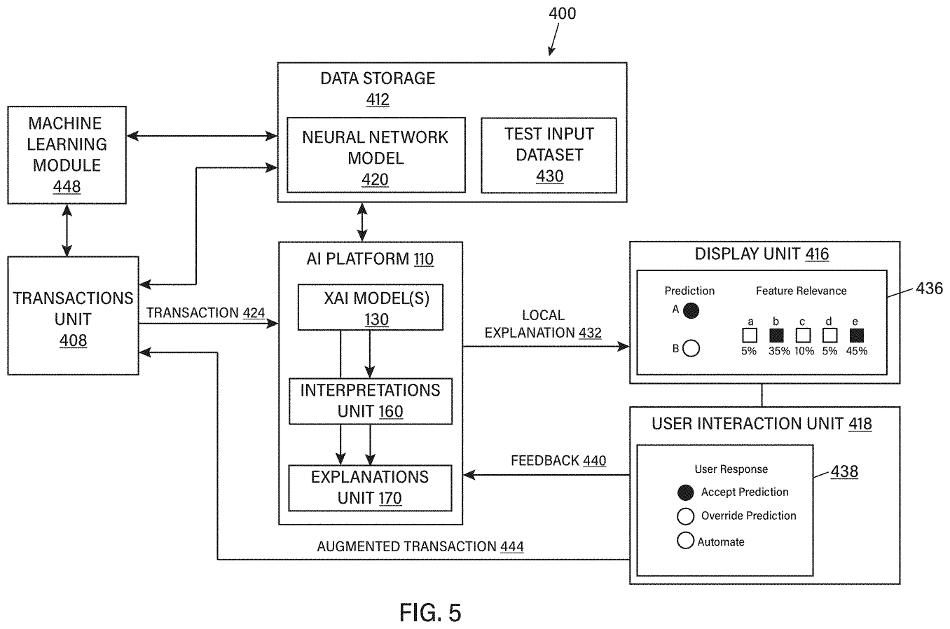

FIG. 5 is a block diagram illustrating an example system 400 implementing local explanation generation. The system 400 includes the AI platform 110, which can communicate with a transactions unit 408, a data storage 412, a display unit 416, and a user interaction unit 418. In the example, the AI platform 110 includes one or more XAI models 130, the interpretations unit 160, and the explanations unit 170 (see Example B).

In one example, the AI platform 110 can fetch a neural network model 420 from the data storage 412 for processing of a transaction 424 received from the transactions unit 408. The neural network model 420 can be a trained NN model. The AI platform 110 can also fetch a test input dataset 430 from the data storage 412 for processing of the transaction 424. The neural network model 420 and the test input dataset 430 can be provided to an XAI model 130 for generation of a local explainability dataset, which can comprise one or more feature relevance vectors populated with relevance scores determined using weights, biases, and prediction probability of the neural network model, as previously described. The AI platform 110 can output a local explanation 432 based on the local explainability dataset.

The display unit 416 can receive the local explanation 432 from the AI platform 110 and provide a representation 436 of the local explanation 432. The user interaction unit 418 can include a set of options 438 that allow a user to interact with the local explanation 432. The user can be a human user or a system. In response to selecting an option from the set of options 438, the user interaction unit 418 can provide further options to the user. For example, if the user wishes to override the prediction(s) of the neural network model, the user interaction unit 418 can further display an interface that allows the user to adjust the prediction.

In some cases, the user interaction unit 418 can send feedback 440 to the AI platform 110 based on changes made at the user interaction unit 418. In some cases, the user interaction unit 418 can also send an augmented transaction 444 to the transactions unit 408. The augmented transaction 444 can include the user response. In some cases, the transactions unit 408 can include or communicate with a machine learning module 448. The machine learning module 448 can in some cases determine whether the neural network model 420 should be retrained or otherwise adjusted based on information contained in the augmented transaction 444. In some cases, the machine learning module 448 can trigger retraining or adjustment of the neural network model. The retrained/adjusted neural network model can be used to make predictions.

### Example H—Example Method Implementing XAI Generation

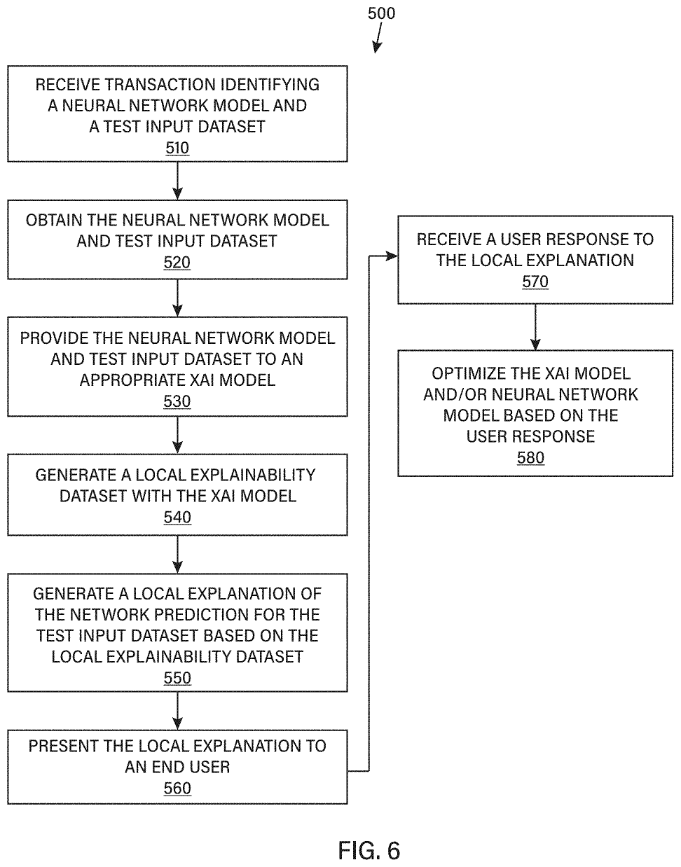

FIG. 6 is a flowchart of an example method 500 implementing XAI generation based on the system 400 (see Example G).

At 510, the method receives a transaction. The transaction contains a request for a local explanation of a prediction of a neural network model for a test input dataset, which can have one or more test input vectors. The neural network model can be a trained NN model. The transaction can include identifying information for the desired neural network model and the test input dataset.

At 520, the method parses the transaction to determine the neural network model to use and obtains the neural network model. The method also obtains the test input dataset.

At 530, the method parses the transaction to determine the XAI model to use in explaining the prediction of the neural network model and provides the neural network model and test input dataset to the appropriate XAI model.

At 540, the method generates local explainability dataset with the XAI model based on the weights, biases, and output of the neural network model for the test input dataset. The local explainability dataset can include one or more feature relevance vectors that quantify the relevance of input features to the network output (or prediction).

At 550, the method generates a local explanation based on the local explainability dataset. The local explanation can be the raw local explainability dataset or information derived from the local explainability dataset. The local explanation can include metadata and the like to improve understanding of the feature relevance vectors in the local explainability dataset within a context of an end user.

At 560, the method can present the local explanation to an end user, which can be a human user or computer.

At 570, the method can receive a user response to the local explanation. For example, the method can present a set of options to the user from which the user can make a selection. For example, the set of options can include “accept the prediction” if the feature relevance seems reasonable and appropriate, “override the prediction” if the feature relevance seems to be in error, and “automate” generation of the prediction because the prediction can be trusted. The method can receive one of the options selected by the user. If the option includes overriding the prediction, the method can ask the user for adjustments to the prediction (e.g., feature relevance scores can be adjusted).

At 580, the method can use the user response for further optimization of the XAI model and/or neural network model. For example, for a given input vector, the neural network model makes a prediction, and the XAI model explains this prediction. A user can, for example, override the prediction and make adjustments to the feature relevance scores indicated in the explanation. These changes can be captured. In one example, a similarity score between the data collected from the user response and the data used in training the neural network model can be computed. If there is sufficient dissimilarity between the user response and the training data, retraining of the neural network model can be triggered. On the other hand, if the similarity score is high but the neural network model performance or explanation of the performance of the model is low, an investigation of the neural network model generalization can be triggered. In general, optimization that can be made can include model retuning, model refinement, delta training, model generalization, addition and/or deletion of models for a subset of problems, change in model architecture, and use of a latest model design. The optimized neural network model can be used to make predictions.

### Example I—Data Model Mapping Tool Implementing AI Explanation Generation

In the example, the transactions unit 408 in FIG. 5 can be a tool supporting the mapping and matching of data structures (or data models). In this case, the transactions unit 408 can provide two semantically similar but different data models to the AI platform 110 for the prediction of the correct mapping with the ambition to maintain accurate data lineage.

The AI platform 110 can fetch the appropriate trained NN model and use the trained NN model to provide the predicted mappings (i.e., the inference). The AI platform 110 can use the appropriate XAI model 130 with the weights and biases of the trained NN model and the predicted mappings to generate one or more feature relevance vectors. The local explainability dataset can include the feature relevance vector(s). The AI platform 110 can add the input features (e.g., semantic context, entity and field names, data types and structures including cardinalities) considered for the prediction as well as the predicted mappings to the local explainability dataset. The AI platform 110 can generate a local explanation based on the local explainability dataset and present the local explanation to a user, e.g., by transmitting the local explanation to the display unit 416.

The display unit 416 can present the local explanation to a user. The user interactions unit 418 can present a set of options to the user based on the local explanation. The options can include, for example, accept the predicted mapping if features and relevance values seem reasonable and appropriate, override the predicted mapping if it appears to be in error or is unrealistic, and automate the mapping if the prediction is trusted and typically proves to be accurate.

The user can select one of the options. Depending on the selected option, additional operations can be performed. For example, if the user selects the option to override the predicted mapping, the user interactions unit 418 can allow the user to adjust the relevant features and their relevance values. In this case, the changes made by the user can be propagated back to the AI platform 110 as feedback and used to optimize the XAI model and/or trained NN model.

An augmented transaction can be fed back to the transactions unit 408 for further processing. The augmented transaction can include, for example, identifying information for the transaction, the local explanation, and any user responses to the local explanation. In some cases, processing of the augmented transaction at the transactions unit 408 can trigger optimization of the trained NN model.

### Example J—Service/Sales Orders Completion Date Prediction Implementing AI Explanation Generation

In the example, the transactions unit 408 in FIG. 5 can be a tool supporting prediction of a service/sales orders completion date. In this case, the transaction provided by the transactions unit 408 to the AI platform 110 can include a request to predict whether an order can be completed within a certain deadline or not. The transaction can further include a request to provide an estimated completion date if the order cannot be completed. The transaction can further include the input data for a trained model that will make the prediction.

The AI platform 110 can fetch the appropriate trained NN model and provide the trained NN model and the input data to the appropriate XAI model 130. The XAI model 130 can generate one or more feature relevance vectors for the input data using weights and biases in the trained NN model and prediction of the trained NN model for the input data. The local explainability dataset can include the feature relevance vector(s). The AI platform 110 can add the input features (e.g., business entities and field names) considered for the prediction as well as the prediction to the local explainability dataset. The AI platform 110 can generate a local explanation based on the local explainability dataset and present the local explanation to a user, e.g., by transmitting the local explanation to the display unit 416.

The display unit 416 can present the local explanation to a user. The user interactions unit 418 can present a set of options to the user based on the local explanation. The options can include, for example, accept the prediction (and corresponding completion date) if features and relevance values seem reasonable and appropriate, override the prediction (and corresponding completion date) if it appears to be in error or is unrealistic, and automate the prediction if it is trusted and typically proves to be accurate.

The user can select one of the options. Depending on the selected option, additional operations can be performed. For example, if the user selects the option to override the predicted mapping, the user interactions unit 418 can allow the user to adjust the relevant features and their relevance values. In this case, the changes made by the user can be propagated back to the AI platform 110 as feedback and used to optimize the XAI model and/or trained NN model.

An augmented transaction can be fed back to the transactions unit 408 for further processing. The augmented transaction can include, for example, identifying information for the transaction, the local explanation, and any user responses to the local explanation. In some cases, processing of the augmented transaction at the transactions unit 408 can trigger optimization of the trained NN model.

### Example K—Next Actions Prediction for Customer Tickets Implementing AI Explanation Generation

In the example, the transactions unit 408 in FIG. 5 can be a tool supporting prediction for customer tickets. In this case, the transaction provided by the transactions unit 408 to the AI platform 110 can include the current stage of the ticket and previous actions and a request to predict the next possible best action and/or next possible best stage along with the reasons behind the prediction of a certain action.

The AI platform 110 can fetch the appropriate trained NN model and provide the trained NN model and input data to the appropriate XAI model 130. The XAI model 130 can generate one or more feature relevance vectors for the input data using weights and biases in the trained NN model and prediction of the trained NN model for the input data. The local explainability dataset can include the feature relevance vector(s). The AI platform 110 can add the input features (e.g., related metadata, previous actions, and field names) considered for the prediction as well as the prediction to the local explainability dataset. The AI platform 110 can generate a local explanation based on the local explainability dataset and present the local explanation to a user, e.g., by transmitting the local explanation to the display unit 416.

The display unit 416 can present the local explanation to a user. The user interactions unit 418 can present a set of options to the user based on the local explanation. The options can include, for example, accept the prediction if features and relevance values seem reasonable and appropriate, override the prediction if it appears to be in error or is unrealistic, and automate the prediction if it is trusted and typically proves to be accurate.

The user can select one of the options. Depending on the selected option, additional operations can be performed. For example, if the user selects the option to override the predicted mapping, the user interactions unit 418 can allow the user to adjust the relevant features and their relevance values. In this case, the changes made by the user can be propagated back to the AI platform 110 as feedback and used to optimize the XAI model and/or trained NN model.

An augmented transaction can be fed back to the transactions unit 408 for further processing. The augmented transaction can include, for example, identifying information for the transaction, the local explanation, and any user responses to the local explanation. In some cases, processing of the augmented transaction at the transactions unit 408 can trigger optimization of the trained NN model.

### Example L—Entities Predictions in Financial Documents Implementing AI Explanation Generation

In the example, the transactions unit 408 in FIG. 5 can be a tool that provides semantic mapping of different financial entities present in different kinds of financial documents (e.g., sales orders, purchase orders, service orders, payment advices, invoices, receipts, payment notes, bank transfers, bank formulas, and the like). The financial documents can be in the form of images without color gradients, which require using nonlinear programming, object detection, and classification to solve. In this case, the transaction provided to the AI platform 110 can include a request to predict the location, class labels, and text string of a financial entity.

The AI platform 404 can retrieve the appropriate trained NN model and provide the trained NN model and input data to the appropriate XAI model 130. The XAI model 130 can generate one or more feature relevance vectors for the input data using weights and biases in the trained NN model and prediction of the trained NN model for the input data. The local explainability dataset can include the feature relevance vector(s). The AI platform 110 can add the input features (e.g., bounding surface, class labels, and text strings) considered for the prediction as well as the prediction to the local explainability dataset. The AI platform 110 can generate a local explanation based on the local explainability dataset and transmit the local explanation to the display unit 416.

The display unit 412 can present the local explanation to a user. The user interactions unit 418 can present a set of options to the user based on the local explanation. The options can include, for example, accept the prediction if features and relevance values seem reasonable and appropriate, override the prediction if it appears to be in error or is unrealistic, and automate the prediction if it is trusted and typically proves to be accurate.

The user can select one of the options. Depending on the selected option, additional operations can be performed. For example, if the user selects the option to override the predicted mapping, the user interactions unit 418 can allow the user to adjust the relevant features and their relevance values. In this case, the changes made by the user can be propagated back to the AI platform 110 as feedback and used to optimize the XAI model and/or trained NN model.

An augmented transaction can be fed back to the transactions unit 408 for further processing. The augmented transaction can include, for example, identifying information for the transaction, the local explanation, and any user responses to the local explanation. In some cases, processing of the augmented transaction at the transactions unit 408 can trigger optimization of the trained NN model.

### Example M—Example Local Explanation

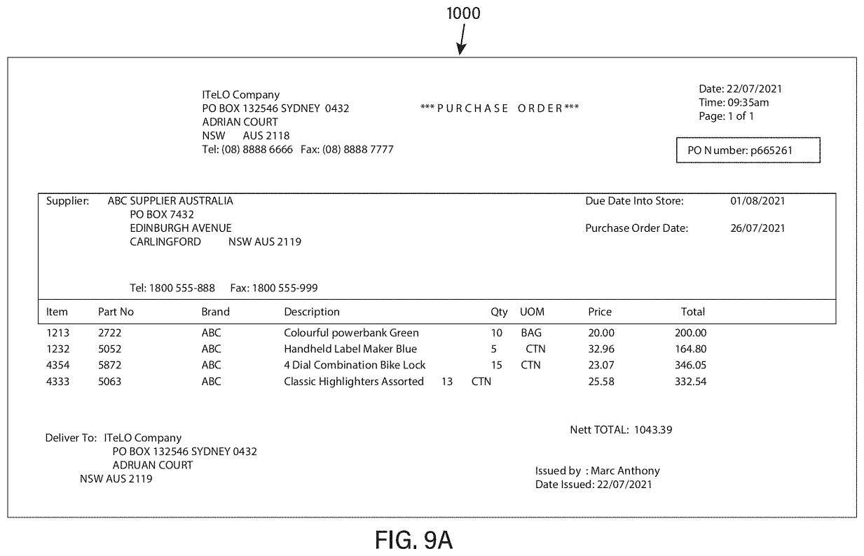

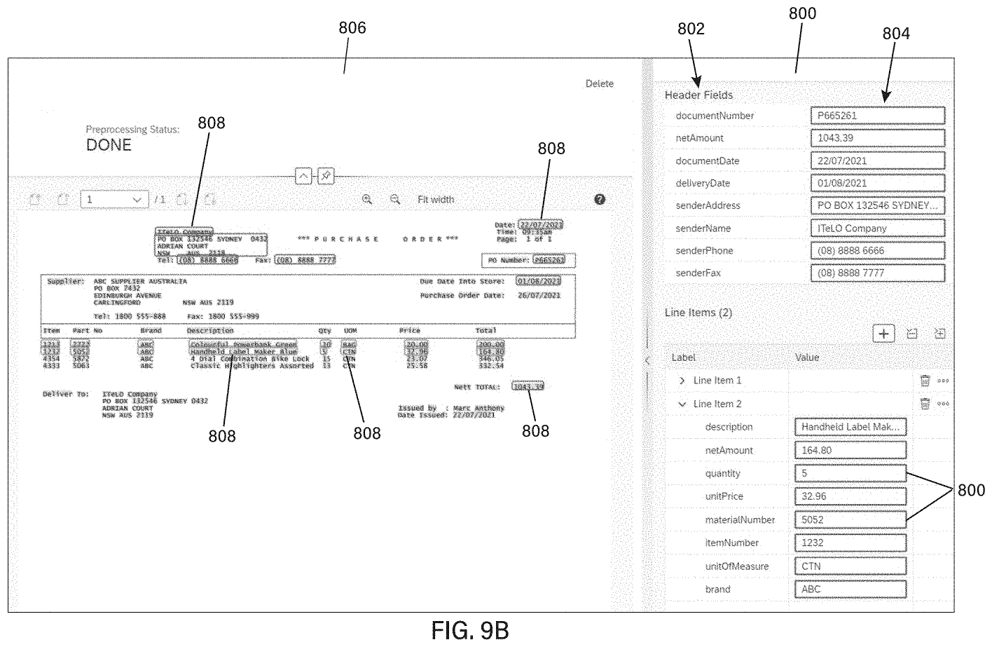

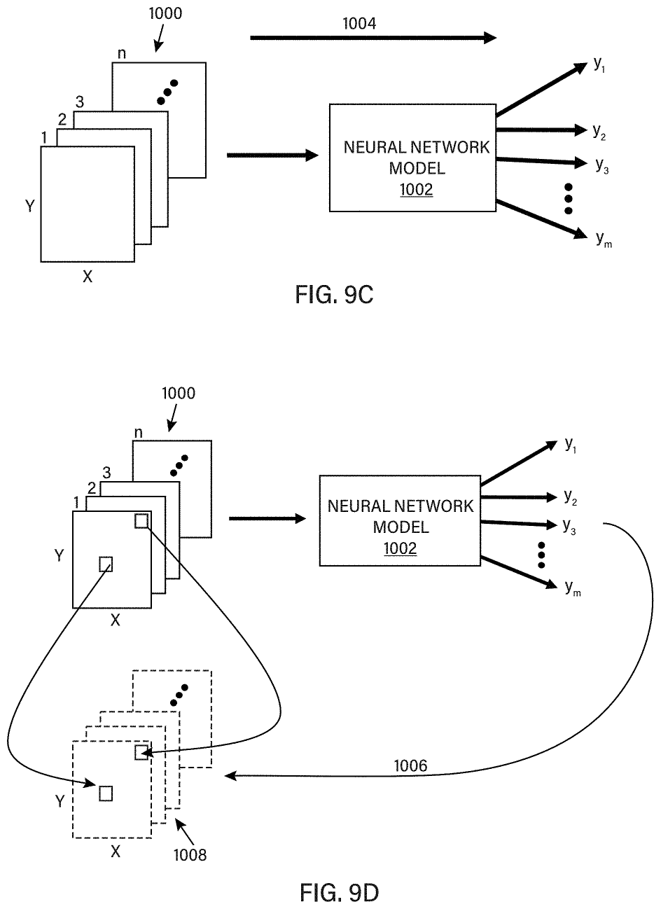

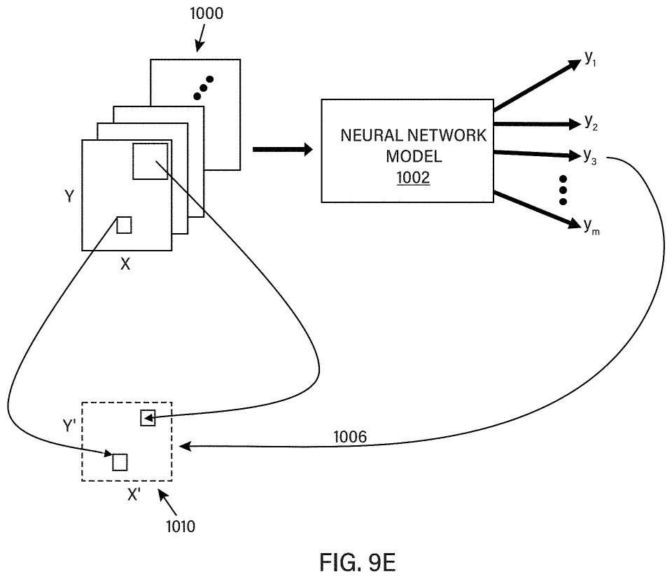

FIG. 9A shows a test image 1000 containing input data for a trained neural network model. The test image is an example of unstructured data, i.e., data not in a defined or structured format. In the example, the test image is an image of a purchase order document. In the example, the neural network model has been trained to identify fields and data in purchase order documents, which can have varying formats and information. The neural network model can identify regions of an image containing fields and data and predict class labels for the regions with a probability. A practical use of the trained neural network model can be to extract data from a purchase order document and store the data in a database for use by other processes.

In one example, the test image can have n channels based on a color model. For example, a grayscale image has one channel, an RGB image has three channels, and a CMYK image has four channels. The test image with n channels can be represented as a high-dimensional vector/high-dimensional matrix or tensor/2D matrix with n channels. The dimensions of an input vector for a test image with n channels will be X*Y*n, where X is the width of the image (which can be measured in pixels), Y is the height of the image (which can be measured in pixels), and n is the number of channels.

For illustrative purposes, FIG. 9C shows a test image 1000 with n channels fed to an input of a trained neural network model 1002. In one example, in the forward path, as indicated by arrow 1004, the neural network model 1002 can accept one test image 1000 and generate one or more predictions y₁, y₂, y₃, . . . , yₘ (m can correspond to the number of fields of interest in the document represented by the test image 1000). In another example, the trained neural network model 1002 can accept multiple test images (as a batch job) and generate one or more predictions for each test image.

Each prediction made by the neural network model has a prediction probability, which can be outputted directly by the neural network model or calculated from the output of the neural network model using Equations (1a), (1b), (2a), and (2b) in Example D. For local explainability calculations, the prediction probability is used to compute an output relevance score that is then traversed/propagated in reverse direction to obtain relevance scores at the first hidden layer of the neural network model 1002, as illustrated by arrow 1006 in FIG. 9D (for clarity, FIG. 9D shows the relevance propagation below the neural network model 1002; however, as previously described, the relevance scores are calculated while traversing through the network layers in a reverse direction).

The relevance scores calculated at the first hidden layer of the neural network model will be in the form of a high dimensional vector/high dimensional matrix or tensor and can be called a relevance map (shown at 1008 in FIG. 9D). In one example, the relevance map 1008 can have the same dimensions as that of the input vector 1008, which means that there will be a 1-1 correspondence between the relevance scores in the relevance map 1008 and the pixels/features in the input vector, as illustrated in FIG. 9D.

In another example, the relevance map can have different dimensions compared to the input vector 1000, requiring an additional mapping technique between the relevance map and the input vector 1000. For example, as illustrated in FIG. 9E, the relevance map 1010 can have a dimension X′*Y′ for the input vector 1000 having a dimension X*Y*n, where n is the number of channels. In this case, an additional technique will be needed to map from X′*Y′ to X*Y*n.

For local explainability, relevance maps are calculated for each output/prediction of the network. Hence, for an input image document, if there are θ number of outputs/predictions made by the network, then θ number of relevance maps will be generated for local explainability. Each field of interest in the document can have a corresponding network prediction and relevance map.

The output of the neural network model can be class labels and the likelihood that certain regions correspond to the class labels. FIG. 9B shows a user interface illustrating an output of the neural network using the test image of FIG. 9A as input. In the right area 800 of the user interface are fields of interest 802 and the data 804 found by the neural network model corresponding to these fields. In the left area 806 of the user interface is the test image of FIG. 9A. Overlaid on the test image are bounding boxes 808 indicating the regions (or a group of pixels) of the test image where the neural network model found data corresponding to the fields of interest. The bounding boxes 808 can be color coded (e.g., by relevance, importance, or to differentiate/group data/fields together).

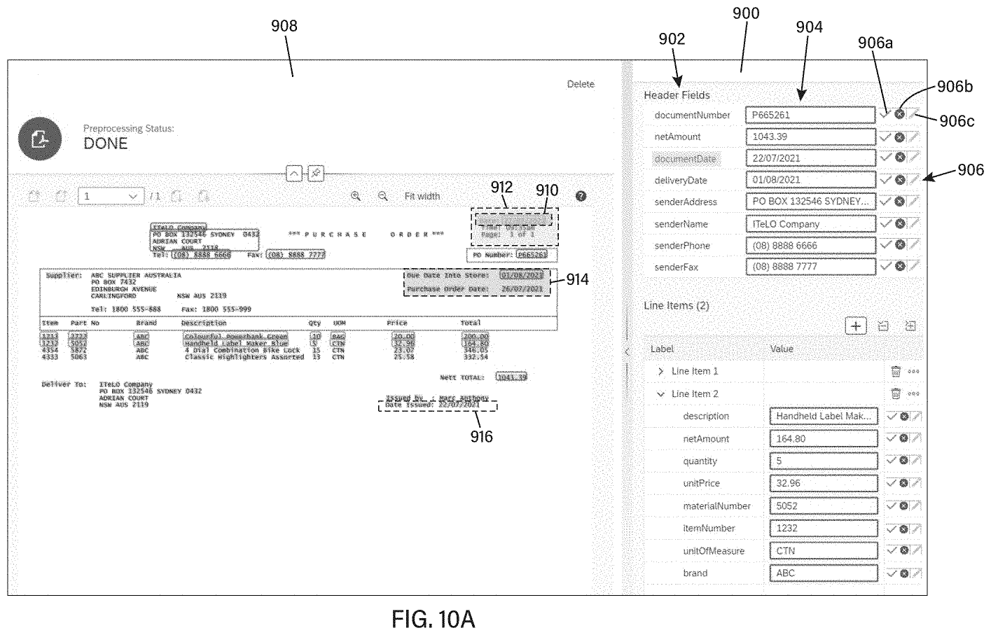

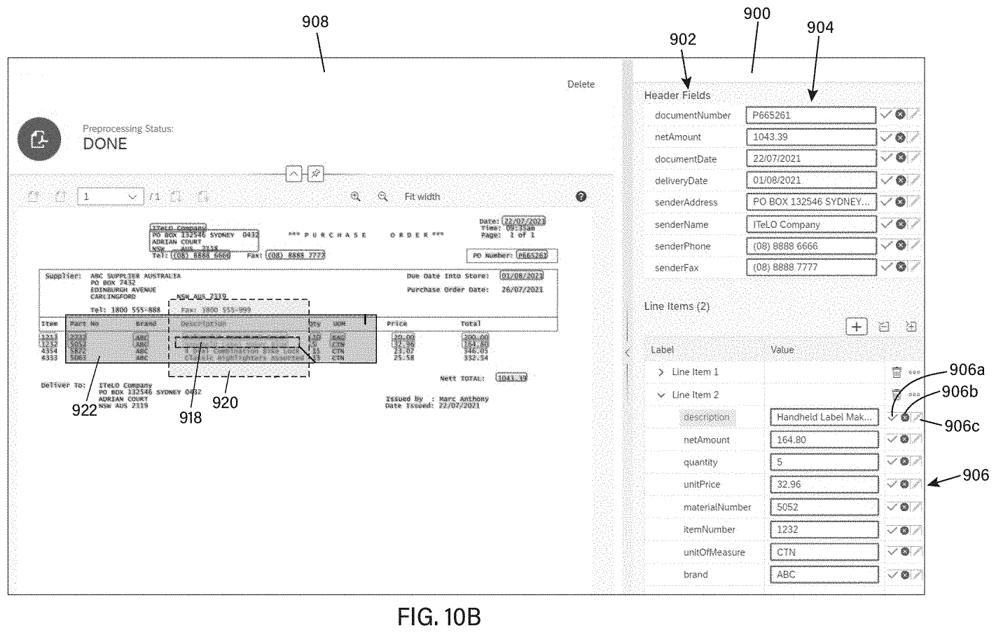

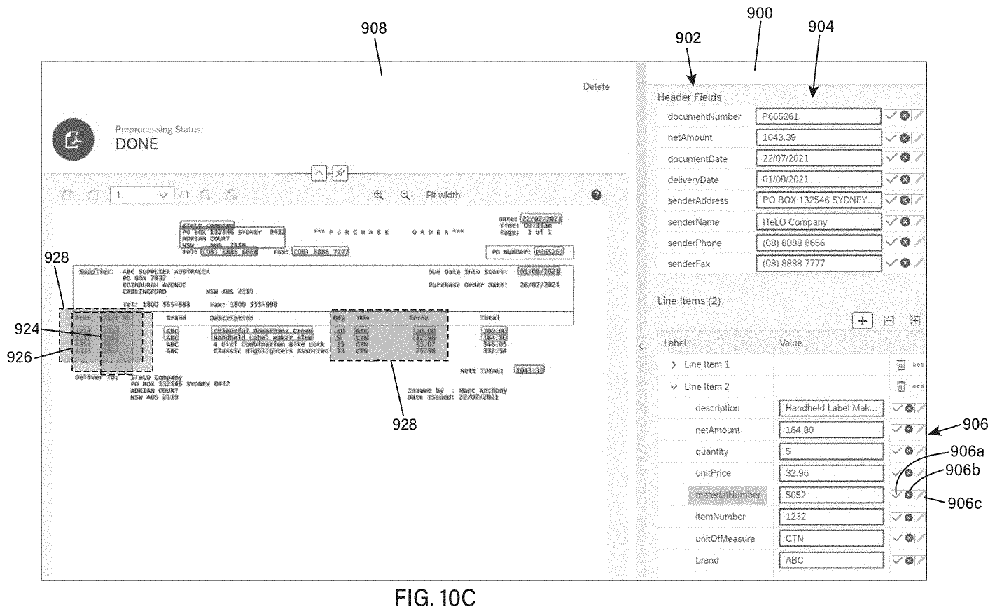

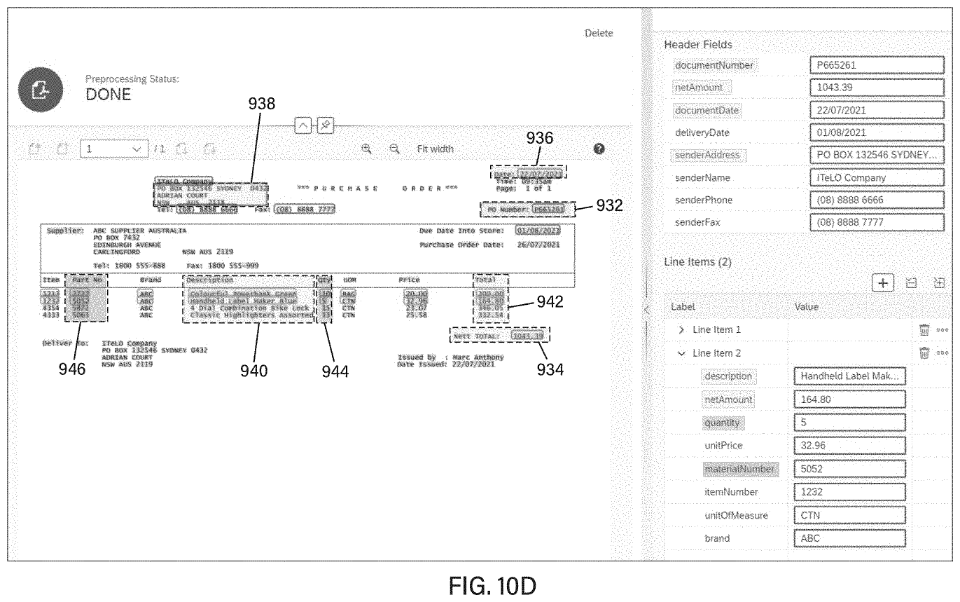

A local explainability dataset can be generated for the neural network model prediction of FIG. 9B using technologies described herein. A local explanation based on the local explainability dataset can be presented to a user. FIGS. 10A-10C show various states of an example user interface presenting explanation of the prediction of the neural network model. The user interface allows user interaction with the prediction (e.g., to accept the prediction, reject the prediction, or edit the prediction). The results of the interaction can be used to adjust/retrain the neural network model in some cases.

In FIG. 10A, in the right region 900 of the user interface are fields of interest 902 and the data 904 found by the neural network model corresponding to these fields. Also shown in the right region 900 is a set of icons 906 that can be used to interact with the prediction of the neural network model. For example, the check mark icon 906a can be used to accept the data found by the neural network model for a particular field, the cross icon 906b can be used to reject the data found by the neural network model for a particular field, and the pencil icon 906c can be used to edit the data found by the neural network. The user interface can have other icons not specifically shown.

In the left region 908 of the user interface of FIG. 10A is the test image of FIG. 9A. Overlaid on the test image are bounding boxes (groups of pixels). The bounding boxes have associated relevance scores that indicate the relevance of the regions of the image within the bounding boxes to the predictions of the network. In the example shown in FIG. 10A, the prediction for the “documentDate” field is shown. Bounding boxes 910, 912, 914 indicate the regions of the test image where the neural network model found data that might correspond to the documentDate. The bounding boxes 910, 912, 914 can be color-coded or otherwise distinguished to indicate the importance or relevance of the indicated regions of the image to the network prediction. In some cases, relevance scores can be displayed by positioning a cursor on the bounding boxes.

In the example, the region identified by the bounding box 910 has a relevance score of 90% for documentDate, the region identified by bounding box 912 has a relevance score of 8% for documentDate, and the region identified by bounding box 914 has a relevance score of 1.9% for documentDate. The region identified by bounding box 910, with the highest relevance score, can be considered to be the most important area or relevant area for documentDate.

The neural network model can use various information to locate the region containing the documentDate. For example, the neural network model can use information such as pixels representing the text “Date”, learned image segments, and location information and associated pixels representing similar text patterns to identify the documentDate. One goal of the local explanation is to discover what information the neural network model might be using to locate the region containing the documentDate. For example, even though there are several regions of the document with date information, the neural network model has favored the area closer to the right top corner of the image as the most likely location of the documentDate.

In one example, a user can select a field on the region 900 of the user interface, and the corresponding prediction of the neural network model and explanation of the prediction for the field can be shown on the region 908 of the user interface. For example, the bounding boxes and any corresponding color coding for the relevant areas of the region 908 can be shown. Using the set of icons 906, a user can indicate whether the prediction of the neural network model as shown on the region 908 of the user interface is correct. For example, bounding box 910 has a relevance score of 90% and correctly identifies the region of the image containing the documentDate. In this case, the user can use the check mark icon 906a to indicate that the prediction is correct. If it turns out that the prediction is not correct (e.g., if the region identified by bounding box 916, which also contains a date, had been identified with a higher relevance score than the region identified by bounding box 910 for documentDate), the user can use the cross icon 906b to delete the prediction. On the other hand, if the neural network model identifies the correct region of the image containing the documentDate but is not capturing all the data, the pencil icon 906c can be used to adjust the data and the explanations bounding box along with providing an option to provide a new value for the relevance score associated with the bounding box.

FIG. 10B illustrates another state of the user interface where the prediction of the neural network model for “description” field of a line item is shown. Bounding boxes 918, 920, 922 indicate the regions of the test image where the neural network model found data that might correspond to the description. For example, the region identified by bounding box 918 has a relevance score of 88%, the region identified by bounding box 920 has a relevance score of 7%, and the region identified by bounding box 922 has a relevance score of 4%. A user can observe whether the local explanations are correct (e.g., whether the region with the highest relevance score corresponds to the description). The set of icons 906 can be used to accept the prediction, reject the prediction, or change the values. In one example, the bounding boxes 918, 920, and 922 can be resized or repositioned to indicate the regions of the image containing the desired data. Any interactions with the explanation and prediction (e.g., through the set of icons 906 and bounding boxes 918, 920, 922) can be transmitted to the transactions unit, as previously described.

FIG. 10C illustrates another state of the user interface where the prediction of the neural network model for “materialNumber” field of a line item is shown. Bounding boxes (or color-coded boxes) 924, 926, and 928 indicate the regions of the test image where the neural network model found data that might correspond to materialNumber. For example, the region identified by the bounding box 924 has a relevance score of 87% for the materialNumber, the region identified by the bounding box 926 has a relevance score of 7% for the materialNumber, and the regions identified by the bounding boxes 928 have a relevance score of 5%. A user can observe whether the local explanations are correct (e.g., whether the region with the highest relevance score contains the materialNumber). The set of icons 906 can be used to accept, reject, or edit the prediction of the materialNumber field.

FIG. 10D illustrates another state of the user interface where the predictions of the neural network model for several fields (e.g., documentNumber, netAmount, documentDate, senderAddress, description (line item), netAmount (line item), quantity (line item), and materialNumber (line item)) are shown. In the example, the bounding boxes 932, 934, 936, 938, 940, 942, 946 identify the regions of the image corresponding to the documentNumber, netAmount, documentDate, senderAddress, description (line item), netAmount (line item), quantity (line item), and materialNumber (line item) fields, respectively. The bounding boxes can correspond to the most important (highly relevant/highest value of relevance scores) areas of the image found for the fields. For example, for the documentDate field, compared bounding box 936 in FIG. 10D to the bounding box 910 in FIG. 10A.

Color coding can be used to indicate the importance or relevance of the regions within the bounding boxes 932, 934, 936, 938, 940, 942, 946 to the network prediction for the test image. In some cases, two or more areas of the image (i.e., two or more bounding boxes) can have equal relevance to the prediction of the neural network model. For example, in FIG. 10D, the regions within the bounding boxes 934, 936, corresponding to documentDate and netAmount, respectively, have equal relevance to the network prediction for the test image.

Thus, in any of the examples herein, the technologies can be applied to the use case of identifying fields in documents. In general, these can be any kind of documents (e.g., purchase orders, sales orders, service orders, invoices, receipts, bank formulas, to name a few). In the example, field names appearing in an image are used to identify database field names of data fields in a document. An explanation can be presented (e.g., which text led to a prediction that a particular data field is to be stored in a predicted field name of a table) to help a reviewing user determine whether the prediction (e.g., that a particular data field is to be stored in a predicted field name of a table) has a correct basis. If not, the user can easily see the incorrect basis and take steps to correct the basis.

### Example Computing Systems

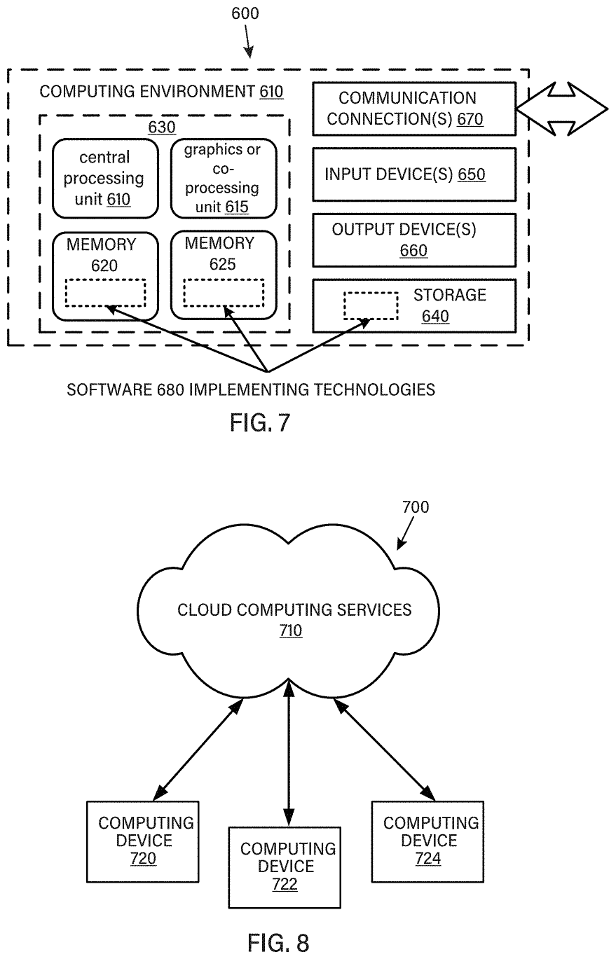

FIG. 7 depicts an example of a suitable computing system 600 in which the described innovations can be implemented. The computing system 600 is not intended to suggest any limitation as to scope of use or functionality of the present disclosure, as the innovations can be implemented in diverse computing systems.

With reference to FIG. 7, the computing system 600 includes one or more processing units 610, 615 and memory 620, 625. In FIG. 7, this basic configuration 630 is included within a dashed line. The processing units 610, 615 execute computer-executable instructions, such as for implementing the features described in the examples herein. A processing unit can be a general-purpose central processing unit (CPU), processor in an application-specific integrated circuit (ASIC), graphics processing unit (GPU), tensor processing unit (TPU), quantum processor, or any other type of processor. In a multi-processing system, multiple processing units execute computer-executable instructions to increase processing power. For example, FIG. 7 shows a central processing unit 610 as well as a graphics processing unit or co-processing unit 615. The tangible memory 620, 625 can be volatile memory (e.g., registers, cache, RAM), non-volatile memory (e.g., ROM, EEPROM, flash memory, etc.), or some combination of the two, accessible by the processing unit(s) 610, 615. The memory 620, 625 stores software 680 implementing one or more innovations described herein, in the form of computer-executable instructions suitable for execution by the processing unit(s) 610, 615.

A computing system 600 can have additional features. For example, the computing system 600 includes storage 640, one or more input devices 650, one or more output devices 660, and one or more communication connections 670, including input devices, output devices, and communication connections for interacting with a user. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 can be removable or non-removable, and includes magnetic disks, magnetic tapes or cassettes, CD-ROMs, DVDs, or any other medium which can be used to store information in a non-transitory way and which can be accessed within the computing system 600. The storage 640 stores instructions for the software 680 implementing one or more innovations described herein.

The input device(s) 650 can be an input device such as a keyboard, mouse, pen, or trackball, a voice input device, a scanning device, touch device (e.g., touchpad, display, or the like) or another device that provides input to the computing system 600. The output device(s) 660 can be a display, printer, speaker, CD-writer, or another device that provides output from the computing system 600, e.g., actuators or some mechanical devices like motors, 3D printers, and the like.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example Cloud Computing Environment

FIG. 8 depicts an example cloud computing environment 700 in which the described technologies can be implemented, including, e.g., the systems described herein. The cloud computing environment 700 comprises cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operations (e.g., data processing, data storage, and the like).

In practice, cloud-based, on-premises-based, or hybrid scenarios can be supported.

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1. A computer-implemented method comprises receiving a request identifying a neural network model, wherein the neural network model comprises a plurality of neurons arranged in a sequence of layers, a plurality of neuron weights distributed across the sequence of layers, a plurality of neuron biases distributed across the sequence of layers, and an input layer configured to receive an input vector with a plurality of input features; feeding a first test input vector having an expected plurality of input features to the input layer to generate a first network output from the neural network model; determining a first output relevance score based on the first network output; generating a plurality of first relevance scores at a last layer of the sequence of layers based on the first output relevance score, the neuron weights in the last layer, and the neuron biases in a lower layer preceding the last layer in the sequence of layers; obtaining a plurality of first relevance scores corresponding to the expected plurality of input features at a first layer of the sequence of layers by reverse propagating the first relevance scores generated at the last layer through the sequence of layers other than the last layer using the neuron weights and the neuron biases; forming a first feature relevance vector based on the first test input vector and the plurality of first relevance scores; generating a local explainability dataset comprising the first feature relevance vector; and generating a local explanation of a prediction of the neural network model based on the local explainability dataset.

Example 2. A method according to Example 1, wherein the sequence of layers comprises a plurality of hidden layers and the last layer, wherein the first layer of the sequence of layers is one of the hidden layers, and wherein the input layer is a lower layer preceding the first layer.

Example 3. A method according to any one of Examples 1-2, wherein the network output is a probability of a predicted output of a neuron in the last layer of the sequence of layers.

Example 4. A method according to any one of Examples 1-2, wherein determining the first output relevance score based on the first network output comprises applying a probability function to the first network output to obtain a probability of a predicted output of a neuron in the last layer of the sequence of layers.

Example 5. A method according to any one of Examples 1-4, wherein each first relevance score generated at the last layer is a linear combination of a neuron bias in a lower layer preceding the last layer and a neuron weight in the last layer multiplied by the first output relevance score.

Example 6. A method according to any one of Examples 2-5, wherein reverse propagating the first relevance scores generated at the last layer through the sequence of layers other than the last layer comprises computing for each of the hidden layers a plurality of first relevance scores based on one or more neuron weights in the each of the hidden layers, one or more neuron biases in a lower layer preceding the each of the hidden layers, and one or more first relevance scores computed in a higher layer succeeding the each of the hidden layers.

Example 7. A method according to Example 6, wherein each first relevance score computed at each of the hidden layers is a linear combination of a weighted relevance term and a bias term, wherein the weighted relevance term is based on the neuron weights in the each of the hidden layers and the first relevance scores in the higher layer succeeding the each one of the hidden layers, and wherein the bias term is based on the neuron biases in the lower layer preceding the each one of the hidden layers.

Example 8. A method according to any one of Examples 6-7, further comprising discarding the first relevance scores computed at a higher layer succeeding the each one of the hidden layers after computing the first relevance scores at the each one of the hidden layers.

Example 9. A method according to any one of Examples 2-8, wherein reverse propagating the plurality of first relevance scores generated at the last layer through the sequence of layers other than the last layer comprises computing for each of the hidden layers a plurality of relevance scores without using neuron activations in the hidden layers.

Example 10. A method according to any one of Examples 1-9, wherein the request further identifies a test input dataset comprising a plurality of test input vectors, and wherein feeding the first test input vector comprises selecting the first test input vector from the test input dataset.

Example 11. A method according to Example 10, further comprising selecting a second test input vector having the expected plurality of input features from the test input dataset; feeding the second test input vector to the input layer to generate a second network output from the neural network model; determining a second output relevance score based on the second network output; generating a plurality of second relevance scores at the last layer of the sequence of layers based on the second output relevance score, the neuron weights in the last layer, and the neuron biases in the lower layer preceding the last layer in the sequence of layers; obtaining a plurality of second relevance scores corresponding to the expected plurality of input features at the first layer of the sequence of layers by reverse propagating the second relevance scores obtained at the last layer through the sequence of layers other than the last layer using the neuron weights and the neuron biases; forming a second feature relevance vector based on the second test input vector and the plurality of second relevance scores; and prior to generating the local explanation of the prediction of the neural network model based on the local explainability dataset, adding the second feature relevance vector to the local explainability dataset.

Example 12. A method according to any one of Examples 1-11, wherein feeding the first test input vector having the expected plurality of input features to the input layer generates a plurality of network outputs from the neural network model.

Example 13. A method according to Example 12, further comprising determining a second output relevance score based on a second network output from the plurality of network outputs; generating a plurality of second relevance scores at the last layer of the sequence of layers based on the second output relevance score, the neuron weights in the last layer, and the neuron biases in the lower layer preceding the last layer in the sequence of layers; obtaining a plurality of second relevance scores corresponding to the expected plurality of input features at the first layer of the sequence of layers by reverse propagating the plurality of second relevance scores obtained at the last layer through the sequence of layers other than the last layer using the neuron weights and the neuron biases; forming a second feature relevance vector based on the first test input vector and the plurality of second relevance scores; and prior to generating the local explanation of the prediction of the neural network model based on the local explainability dataset, adding the second feature relevance vector to the local explainability dataset.

Example 14. A method according to any one of Examples 1-13, wherein the neural network model is a trained neural network model, and further comprising retraining the neural network model based at least in part on the local explanation.

Example 15. A method according to any one of Examples 1-13, wherein the neural network model is a trained neural network model, and further comprising receiving an adjustment to the local explanation and retraining the neural network model based at least in part on the adjustment to the local explanation.

Example 16. One or more non-transitory computer-readable storage media storing computer-executable instructions for causing a computer system to perform operations comprising receiving a request identifying a neural network model, wherein the neural network model comprises a plurality of neurons arranged in a sequence of layers, a plurality of neuron weights distributed across the sequence of layers, a plurality of neuron biases distributed across the sequence of layers, and an input layer configured to receive an input vector with a plurality of input features; feeding a test input vector having an expected plurality of input features to the input layer to generate a network output from the neural network model; determining an output relevance score based on the network output; generating a plurality of relevance scores at a last layer of the sequence of layers based on the output relevance score, the neuron weights in the last layer, and the neuron biases in a lower layer preceding the last layer in the sequence of layers; obtaining a plurality of relevance scores corresponding to the expected plurality of input features at a first layer of the sequence of layers by reverse propagating the relevance scores generated at the last layer through the sequence of layers other than the last layer using the neuron weights and the neuron biases; forming a feature relevance vector based on the test input vector and the plurality of relevance scores; generating a local explainability dataset comprising the feature relevance vector; and generating a local explanation of a prediction of the neural network model based on the local explainability dataset.

Example 17. One or more non-transitory computer-readable storage media according to Example 16, wherein the sequence of layers comprises a plurality of hidden layers and the last layer, wherein the first layer of the sequence of layers is one of the hidden layers, and wherein the input layer is a lower layer preceding the first layer, and wherein reverse propagating the first relevance scores through the sequence of layers other than the last layer comprises computing for each of the hidden layers a plurality of relevance scores without using neuron activations in the hidden layers.

Example 18. One or more non-transitory computer-readable storage media according to Example 16, wherein reverse propagating the first relevance scores through the sequence of layers other than the last layer comprises computing for each of the hidden layers a plurality of relevance scores, wherein each relevance score computed at each of the hidden layers is a linear combination of a weighted relevance term and a bias term, wherein the weighted relevance term is based on the neuron weights in the each of the hidden layers and the relevance scores in the higher layer succeeding the each one of the hidden layers, and wherein the bias term is based on the neuron biases in the lower layer preceding the each one of the hidden layers.

Example 19. One or more non-transitory computer-readable storage media according to any one of Examples 16-18, wherein each first relevance score determined at the last layer is a linear combination of a neuron bias in a lower layer preceding the last layer and a product of a neuron weight in the last layer and the output relevance score.

Example 20. A computing system comprising one or more processing units coupled to memory; one or more computer readable storage media storing instructions that when executed cause the computing system to perform operations comprising receiving a request identifying a neural network model, wherein the neural network model comprises a plurality of neurons arranged in a sequence of layers, a plurality of neuron weights distributed across the sequence of layers, a plurality of neuron biases distributed across the sequence of layers, and an input layer configured to receive an input vector with a plurality of input features; feeding a test input vector having an expected plurality of input features to the input layer to generate a network output from the neural network model; determining an output relevance score based on the network output; generating a plurality of relevance scores at a last layer of the sequence of layers based on the output relevance score, the neuron weights in the last layer, and the neuron biases in a lower layer preceding the last layer in the sequence of layers; obtaining a plurality of relevance scores corresponding to the expected plurality of input features at a first layer of the sequence of layers by reverse propagating the relevance scores generated at the last layer through the sequence of layers other than the last layer without using neuron activations in the sequence of layers; forming a feature relevance vector based on the test input vector and the plurality of relevance scores; generating a local explainability dataset comprising the feature relevance vector; and generating a local explanation of a prediction of the neural network model based on the local explainability dataset.

### Example Implementation

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example Alternatives

The technology has been described with a selection of implementations and examples, but these preferred implementations and examples are not to be taken as limiting the scope of the technology since many other implementations and examples are possible that fall within the scope of the disclosed technology. The scope of the disclosed technology includes what is covered by the scope and spirit of the following claim.

1. A computer-implemented method comprising:
receiving a request identifying a neural network model, wherein the neural network model comprises a plurality of neurons arranged in a sequence of layers, a plurality of neuron weights distributed across the sequence of layers, a plurality of neuron biases distributed across the sequence of layers, and an input layer configured to receive an input vector with a plurality of input features;
feeding a first test input vector having an expected plurality of input features to the input layer to generate a first network output from the neural network model;
determining a first output relevance score based on the first network output;
generating a plurality of first relevance scores at a last layer of the sequence of layers based on the first output relevance score, the neuron weights in the last layer, and the neuron biases in a lower layer preceding the last layer in the sequence of layers;
obtaining a plurality of first relevance scores corresponding to the expected plurality of input features at a first layer of the sequence of layers by reverse propagating the first relevance scores generated at the last layer through the sequence of layers other than the last layer using the neuron weights and the neuron biases;
forming a first feature relevance vector based on the first test input vector and the plurality of first relevance scores obtained at the first layer;
generating a local explainability dataset comprising the first feature relevance vector; and
generating a local explanation of a prediction of the neural network model based on the local explainability dataset.

2. The method of claim 1, wherein the sequence of layers comprises a plurality of hidden layers and the last layer, wherein the first layer of the sequence of layers is one of the hidden layers, and wherein the input layer is a lower layer preceding the first layer.

3. The method of claim 2, wherein the network output is a probability of a predicted output of a neuron in the last layer of the sequence of layers.

4. The method of claim 2, wherein determining the first output relevance score based on the first network output comprises applying a probability function to the first network output to obtain a probability of a predicted output of a neuron in the last layer of the sequence of layers.

5. The method of claim 2, wherein each first relevance score generated at the last layer is a linear combination of a neuron bias in a lower layer preceding the last layer and a neuron weight in the last layer multiplied by the first output relevance score.

6. The method of claim 2, wherein reverse propagating the first relevance scores generated at the last layer through the sequence of layers other than the last layer comprises computing for each one of the hidden layers a plurality of first relevance scores based on one or more neuron weights in the each one of the hidden layers, one or more neuron biases in a lower layer preceding the each one of the hidden layers, and one or more first relevance scores computed in a higher layer succeeding the each one of the hidden layers.

7. The method of claim 6, wherein each first relevance score computed at each one of the hidden layers is a linear combination of a weighted relevance term and a bias term, wherein the weighted relevance term is based on the neuron weights in the each one of the hidden layers and the first relevance scores in the higher layer succeeding the each one of the hidden layers, and wherein the bias term is based on the neuron biases in the lower layer preceding the each one of the hidden layers.

8. The method of claim 6, further comprising discarding the first relevance scores computed at a higher layer succeeding the each one of the hidden layers after computing the first relevance scores at the each one of the hidden layers.

9. The method of claim 2, wherein reverse propagating the plurality of first relevance scores generated at the last layer through the sequence of layers other than the last layer comprises computing for each of the hidden layers a plurality of first relevance scores without using neuron activations in the hidden layers.

10. The method of claim 1, wherein the request further identifies a test input dataset comprising a plurality of test input vectors, and wherein feeding the first test input vector comprises selecting the first test input vector from the test input dataset.

11. The method of claim 10, further comprising:
selecting a second test input vector having the expected plurality of input features from the test input dataset;
feeding the second test input vector to the input layer to generate a second network output from the neural network model;
determining a second output relevance score based on the second network output;
generating a plurality of second relevance scores at the last layer of the sequence of layers based on the second output relevance score, the neuron weights in the last layer, and the neuron biases in the lower layer preceding the last layer in the sequence of layers;
obtaining a plurality of second relevance scores corresponding to the expected plurality of input features at the first layer of the sequence of layers by reverse propagating the second relevance scores generated at the last layer through the sequence of layers other than the last layer using the neuron weights and the neuron biases;
forming a second feature relevance vector based on the second test input vector and the plurality of second relevance scores obtained at the first layer; and
prior to generating the local explanation of the prediction of the neural network model based on the local explainability dataset, adding the second feature relevance vector to the local explainability dataset.

12. The method of claim 1, wherein feeding the first test input vector having the expected plurality of input features to the input layer generates a plurality of network outputs from the neural network model.

13. The method of claim 12, further comprising:
determining a second output relevance score based on a second network output from the plurality of network outputs;
generating a plurality of second relevance terms at the last layer of the sequence of layers based on the second output relevance score, the neuron weights in the last layer, and the neuron biases in the lower layer preceding the last layer in the sequence of layers;
obtaining a plurality of second relevance scores corresponding to the expected plurality of input features at the first layer of the sequence of layers by reverse propagating the plurality of second relevance terms through the sequence of layers other than the last layer using the neuron weights and the neuron biases;
forming a second feature relevance vector based on the first test input vector and the plurality of second relevance scores; and
prior to generating the local explanation of the prediction of the neural network model based on the local explainability dataset, adding the second feature relevance vector to the local explainability dataset.

14. The method of claim 1, wherein the neural network model is a trained neural network model, and further comprising retraining the neural network model based at least in part on the local explanation.

15. The method of claim 1, wherein the neural network model is a trained neural network model, and further comprising receiving an adjustment to the local explanation and retraining the neural network model based at least in part on the adjustment to the local explanation.

16. One or more non-transitory computer-readable storage media storing computer-executable instructions for causing a computer system to perform operations comprising:
receiving a request identifying a neural network model, wherein the neural network model comprises a plurality of neurons arranged in a sequence of layers, a plurality of neuron weights distributed across the sequence of layers, a plurality of neuron biases distributed across the sequence of layers, and an input layer configured to receive an input vector with a plurality of input features;
feeding a test input vector having an expected plurality of input features to the input layer to generate a network output from the neural network model;
determining an output relevance score based on the network output;
generating a plurality of relevance scores at a last layer of the sequence of layers based on the output relevance score, the neuron weights in the last layer, and the neuron biases in a lower layer preceding the last layer in the sequence of layers;
obtaining a plurality of relevance scores corresponding to the expected plurality of input features at a first layer of the sequence of layers by reverse propagating the relevance scores generated at the last layer through the sequence of layers other than the last layer using the neuron weights and the neuron biases;
forming a feature relevance vector based on the test input vector and the plurality of relevance scores;
generating a local explainability dataset comprising the feature relevance vector; and
generating a local explanation of a prediction of the neural network model based on the local explainability dataset.

17. The one or more non-transitory computer-readable storage media of claim 16, wherein the sequence of layers comprises a plurality of hidden layers and the last layer, wherein the first layer of the sequence of layers is one of the hidden layers, and wherein the input layer is a lower layer preceding the first layer, and wherein reverse propagating the first relevance scores through the sequence of layers other than the last layer comprises computing for each of the hidden layers a plurality of relevance scores without using neuron activations in the hidden layers.

18. The one or more non-transitory computer-readable storage media of claim 16, wherein reverse propagating the first relevance scores through the sequence of layers other than the last layer comprises computing for each of the hidden layers a plurality of relevance scores, wherein each relevance score computed at each of the hidden layers is a linear combination of a weighted relevance term and a bias term, wherein the weighted relevance term is based on the neuron weights in the each of the hidden layers and the relevance scores in the higher layer succeeding the each one of the hidden layers, and wherein the bias term is based on the neuron biases in the lower layer preceding the each one of the hidden layers.

19. The one or more non-transitory computer-readable storage media of claim 16, wherein each first relevance score determined at the last layer is a linear combination of a neuron bias in a lower layer preceding the last layer and a product of a neuron weight in the last layer and the output relevance score.

20. A computing system comprising:
one or more processing units coupled to memory; and
one or more computer readable storage media storing instructions that when executed cause the computing system to perform operations comprising:
receiving a request identifying a neural network model, wherein the neural network model comprises a plurality of neurons arranged in a sequence of layers, a plurality of neuron weights distributed across the sequence of layers, a plurality of neuron biases distributed across the sequence of layers, and an input layer configured to receive an input vector with a plurality of input features;
feeding a test input vector having an expected plurality of input features to the input layer to generate a network output from the neural network model;
determining an output relevance score based on the network output;
generating a plurality of relevance scores at a last layer of the sequence of layers based on the output relevance score, the neuron weights in the last layer, and the neuron biases in a lower layer preceding the last layer in the sequence of layers;
obtaining a plurality of relevance scores corresponding to the expected plurality of input features at a first layer of the sequence of layers by reverse propagating the relevance scores generated at the last layer through the sequence of layers other than the last layer without using neuron activations in the sequence of layers;
forming a feature relevance vector based on the test input vector and the plurality of relevance scores;
generating a local explainability dataset comprising the feature relevance vector; and
generating a local explanation of a prediction of the neural network model based on the local explainability dataset.
